(19) United States
(12) Patent Application Publication
(10) Pub. No.: US 2025/0074591 A1
(43) Pub. Date: Mar. 6, 2025

(54) COMMERCIAL AIRCRAFT FOR SHORT DISTANCE TRAVEL

(71) Applicant: JETZERO, INC., Long Beach, CA (US)

(72) Inventors: Blaine Knight Rawdon, Long Beach, CA (US); John Charles Vassberg, Long Beach, CA (US)

(73) Assignee: JETZERO, INC., Long Beach, CA (US)

(21) Appl. No.: 18/242,746

(22) Filed: Sep. 6, 2023

(51) Int. Cl. B64C 39/10; B64C 3/56; B64D 11/06

(52) U.S. Cl. CPC B64C 39/10; B64C 3/56; B64D 11/06; B64C 2039/105

(57) ABSTRACT

A commercial aircraft for short distance air travel, the commercial aircraft comprising a blended wing body aircraft having a main body, a transition and wings with no clear demarcation between the wings and the main body along a leading edge of the commercial aircraft, a passenger cabin, the passenger cabin located within the main body and having a wide body passenger capacity, at least a propulsor, the at least a propulsor attached to a portion of the main body and configured to propel the blended wing body commercial aircraft through air, a fuel storage located within the blended wing body, the fuel storage having a fuel capacity wherein the fuel capacity is configured for a fuel capacity associated with short-range flight, and a landing gear, the landing gear located on an undercarriage of the blended wing body, the landing gear configured for the short-range flight.

### FIELD OF THE INVENTION

The present invention generally relates to the field of commercial aircraft. In particular, the present invention relates to short range commercial aircraft having a wide body passenger capacity.

### BACKGROUND

Presently, larger, heavier tube and wing aircraft are capable of travelling long distances while smaller, lighter tube and wing aircraft are restricted to shorter routes. Commercial jet transports cannot efficiently transport a larger capacity of passengers over a short range.

### SUMMARY OF THE DISCLOSURE

In an aspect, a commercial aircraft for short distance air travel is illustrated. The commercial aircraft includes a blended wing body aircraft having a main body, a transition and wings with no clear demarcation between the wings and the main body along a leading edge of the commercial aircraft. The commercial aircraft further includes a passenger cabin, the passenger cabin located within the main body and having a wide body passenger capacity, at least a propulsor, the at least a propulsor attached to a portion of the main body and configured to propel the blended wing body commercial aircraft through air, a fuel storage located within the blended wing body, the fuel storage having a fuel capacity wherein the fuel capacity is configured for a fuel capacity associated with short-range flight, and a landing gear, the landing gear located on an undercarriage of the blended wing body, the landing gear configured for the short-range flight.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a schematic top view of an exemplary commercial aircraft for short distance travel;

FIG. 2 is a side view illustration of an exemplary aircraft;

FIG. 3 illustrates an exemplary aircraft having an exemplary egress in a front view;

FIG. 4 is a front view of an exemplary tube wing aircraft;

FIG. 5 is an exemplary view illustrating an exemplary structural floor for a blended wing body aircraft;

FIG. 6 is a schematic of an exemplary blended wing aircraft;

FIG. 7 is a block diagram of a computing system that can be used to implement any one or more of the methodologies disclosed herein and any one or more portions thereof.

The drawings are not necessarily to scale and may be illustrated by phantom lines, diagrammatic representations and fragmentary views. In certain instances, details that are not necessary for an understanding of the embodiments or that render other details difficult to perceive may have been omitted.

### DETAILED DESCRIPTION

At a high level, aspects of the present disclosure are directed to a commercial aircraft for short distance travel. Commercial aircraft includes a blended body wing aircraft. Blended body aircraft may be structured such that the amount of fuel on the aircraft does not depend on the size of the main body. For example, and without limitation, a smaller main body may still have a fuel capacity similar to that of an aircraft with a larger main body. Blended body wing aircraft may travel up to 3000 nautical miles and may include structural elements to contain a pressure vessel.

Aspects of the present disclosure can be used to transport a wide body capacity of passengers over a short distance without the use of multiple aircraft. Aspects of the present disclosure can also be used to conserve on fuel costs when transporting a large capacity of passengers using a large long-range aircraft is not fuel efficient. In some cases, a large blended wing body aircraft may be advantageous over a large tube and wing airliner. For example, in some cases a large tube and wing airliner takes a relatively long time to load and unload because of their linear nature and usually few entry/exit doors. In some cases, this long time subtracts from flight time, hurting productivity and increasing costs, especially on short routes. In contrast, a blended wing body airliner may provide multiple aisles and doors, speeding loading and unloading. In some cases, this may improve productivity and reduce cost on short flights. Typically, large capacity tube and wing airliners may have wingspans that exceed airport limitations for many airports used for short range flights. In some cases, a blended wing body aircraft may employ a folding wing that enables large capacity blended wing body airliners to operate at short range airports intended for smaller airplanes.

Exemplary embodiments illustrating aspects of the present disclosure are described below in the context of several specific examples.

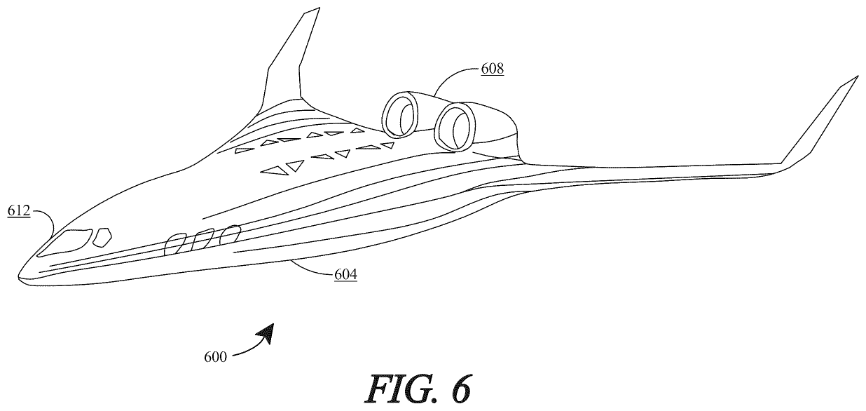

In the following description, for the purposes of explanation, numerous specific details are set forth in order to provide a thorough understanding of the present invention. For purposes of description herein, relating terms, including “upper”, “lower”, “left”, “rear”, “right”, “front”, “vertical”, “horizontal”, and derivatives thereof relate to embodiments oriented as shown for exemplary purposes in FIG. 6. Furthermore, there is no intention to be bound by any expressed or implied theory presented in this disclosure.

Aircraft range increases with greater fuel fraction. Tube and wing aircraft are limited to a fuel fraction approximately proportional to the three-halves power of the tube and wing aircraft's maximum takeoff gross weight. As a result, larger, heavier aircraft are capable of travelling long distances while smaller, lighter aircraft are restricted to shorter routes. Commercial tube and wing jet transports cannot efficiently transport a smaller capacity of passengers over a long range.

“Fuel fraction” as described herein is the maximum distance an aircraft can travel without refueling. Fuel fraction may be calculated as the fuel weight of an aircraft at takeoff divided by an airplane maximum takeoff gross weight (MTOGW). MTOGW may be defined as the sum of three weight components: the payload of an aircraft, the fuel of the aircraft and the operating empty weight of the aircraft. Fuel fraction may increase as fuel weight increases. In addition, operating empty weight and MTOGW of an aircraft may be constant throughout a plurality of different sized aircraft. This causes fuel weight and payload weight to be directly proportional. As a result, as fuel weight increases, thereby increasing fuel fraction, payload weight must decrease.

With respect to tube and wing aircraft, fuel weight of an aircraft at takeoff is proportional to a wing area of an aircraft to the power of 3/2. This is due to the square cube law in which the wing area is proportional to the wingspan squared, and the wing volume is proportional to the wingspan cubed, wherein fuel is stored within a portion of wing volume. In a tube and wing aircraft, fuel volume may only be increased only if wing volume and wing length are increased.

In addition, in tube and wing aircraft, wing area is proportional to MTOGW. Wing loading on a tube and wing aircraft may be constant due to regulatory constraints. Wing loading is defined as the MTOGW divided by an aircraft wing area. Larger wing loading on a tube and wing aircraft requires a larger field length for takeoff and landing. As a result, in order to ensure that larger field length is not required for takeoff and landing, an increase in MTOGW may cause an increase in wing area.

Since wing area is proportional to MTOGW on a tube and wing and fuel weight is proportional to wing area to the power of 3/2 on a tube and wing, an increase in fuel weight must increase the MTOGW. As a result, a lighter tube and wing aircraft must have a smaller fuel fraction and therefore travel shorter distances while a heavier tube and wing aircraft may contain a larger fuel fraction and can therefore travel larger distances. Due to the relationship between fuel weight and MTOGW, a tube and wing aircraft having a larger fuel fraction may be larger and carry more passengers to be feasible while tube and wing aircraft having a lower fuel fraction may be smaller and carry less passengers in order to save on fuel costs.

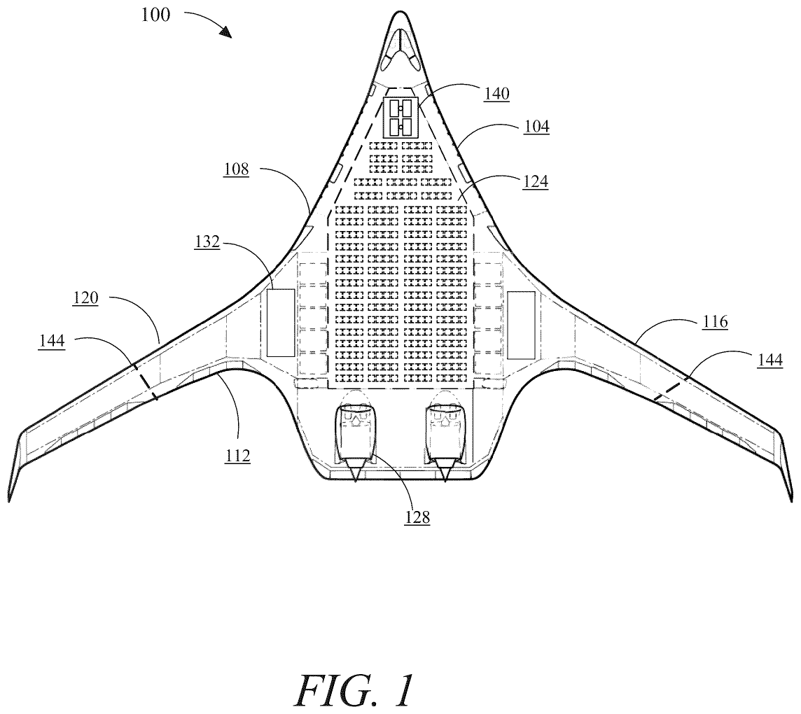

Referring now to FIG. 1, an exemplary embodiment of a commercial aircraft 100 for short distance air travel is illustrated. Aircraft includes a blended wing body 104 having a main body 108 and wings 116. A “commercial aircraft” as described in this disclosure is an aircraft engaged in the business of transporting passengers or cargo from one destination to another. A “BWB” (BWB 104), also known as a “blended body” or a “hybrid wing body” (HWB), is a fixed-wing aircraft body having no clear or abrupt demarcation between wings 116 and a main body 108 of the aircraft along a leading edge of the aircraft. For example, a BWB 104 aircraft may have distinct wings and body structures, which are smoothly blended together with no clear dividing line or boundary feature between wings 116 and fuselage. This contrasts with a flying wing, which has no distinct fuselage, and a lifting body, which has no distinct wings 116. A BWB 104 design may or may not be tailless. One potential advantage of a BWB 104 may be to reduce wetted area and any accompanying drag associated with a tube and wing wing-body junction. In some cases, a BWB 104 may also have a wide airfoil-shaped body, allowing entire aircraft to generate lift and thereby facilitate reduction in size and/or drag of wings 116. In some cases, BWB 104 may be understood as a hybrid shape that resembles a flying wing 116, but also incorporates features from tube and wing aircraft. In some cases, this combination may offer several advantages over tube-and-wing airframes. In some cases, a BWB airframe may help to increase fuel economy and create larger payload (cargo or passenger) volumes within BWB 104. BWB 104 may allow for advantageous interior designs. For instance, cargo can be loaded and/or passengers can board from the front or rear of the aircraft. A cargo or passenger area may be distributed across a relatively wide (when compared to tube-wing aircraft) fuselage, providing a large usable volume. In some embodiments, passengers seated within an interior of aircraft, real-time video at every seat can take place of window seats. As described in this disclosure “main body 108” is a portion of BWB 104 that is capable of holding passengers and/or cargo. In some embodiments, main body 108 may refer to a fuselage of the aircraft. In some embodiments, main body 108 may be contrasted to a tube and wing body aircraft, wherein the aircraft tube and wing body contains a clear transition 112 between the fuselage and the aircraft wing 116. Further disclosure about a fuselage is described in detail below, for example with reference to FIG. 6.

With continued reference to FIG. 1, BWB 104 includes wings 116. “Wing” as described in this disclosure is a fin or an extended member that produces lift for an aircraft while an aircraft is traveling through air. Wings 116 is described in further detail below. Wings 116 may include folding wings 120 wherein a portion of wings 116 may fold to minimize a width of BWB 104 aircraft. For example, wings 116 may be folded when an aircraft hangar cannot contain BWB 104 with extended wing 116. In some embodiments, folding wings 120 may allow for commercial aircraft 100 to service more airports by maximizing airport compatibility. In another non-limiting example, wings 116 may be folded after a flight in order to fit on an aircraft runaway having size constraints smaller than BWB 104 having extended wings 116. Folding wings 120 may include hinges along a portion of wings 116 wherein folding wings 120 may fold in a direction of main body 108. Folding wing 120 may further include wings 116 that fold in a direction parallel to main body 108. “Hinge” as described herein is a mechanism that is attached to at least two components and allows for movement of the at least two components relative to each other. In some cases, a hinge may include a bearing element. In some cases, a hinge may allow for rotation between at least two components, for example over a limited range of motion. Hinge may further refer to any hinge as described in this disclosure. In some cases, hinge may be located on wings 116. In some cases, hinge may be located on main body and configured to allow folding of the folding wings. Alternatively, or additionally, in some cases, hinge may be located within main body 108 and/or a transitional portion between wings 116 and main body 108. In some embodiments, hinge may be configured to fold wings 120 in any direction or manner and may include any hinge arrangement. For example, hinge 144 may fold wings 120 upward and inward. Hinge may be arranged to allow wings 116 to fold directly inward (and beside) aircraft 100. In one or more embodiments, hinge may be located on a portion of wings 116 and configured to arrest motion of wings. In one or more embodiments, hinge may be configured to arrest movement of a hinged wing portion wherein the hinged wing portion includes a portion of wing that has been, and/or is capable of being, folded. Hinge may be arranged to allow wings 116 to fold directly inward (and over) commercial aircraft 100. In some embodiments, hinge may allow wings 116 to fold aftward (and beside) commercial aircraft 100, such as without limitation a B-1 fold. In some cases, hinge may allow wings to twist and fold, such without limitation a Grumman fold.

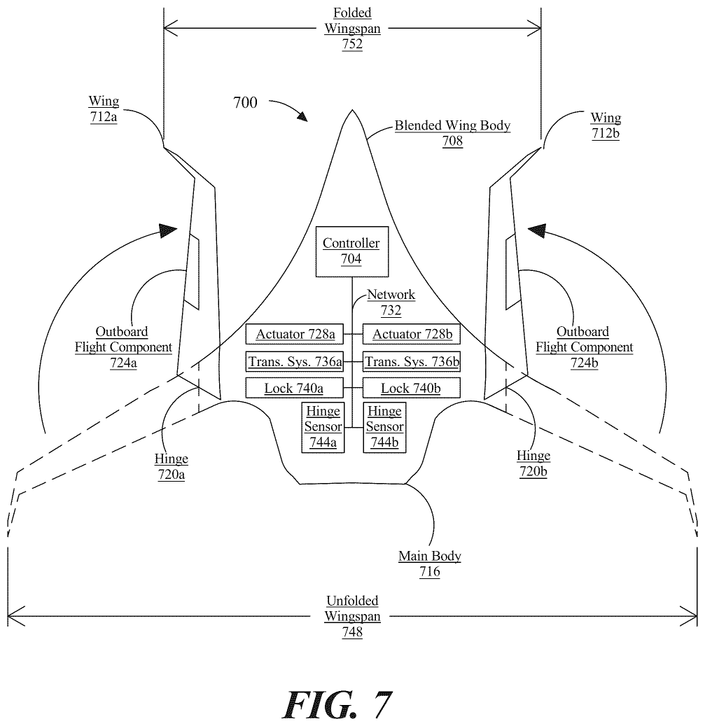

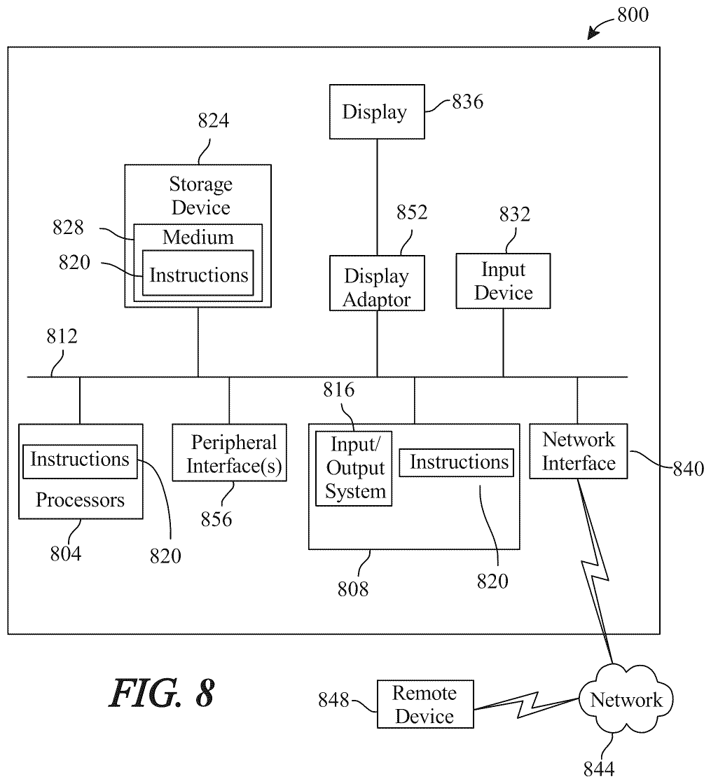

With continued reference to FIG. 1, commercial aircraft 100 may include an actuation system configured to fold folding wings. As used in this disclosure, an “actuation system” or “actuator” is a system that is configured to provide power (i.e., effort [force, torque, pressure, etc.] and flow [velocity, rotation velocity, volumetric flow, etc.]), work, or energy to generate a movement. In some cases, an actuation system may be mechanically communicative with a hinge and provide power, work, or energy to move the hinge. In some cases, an actuating system may be configured to fold wings 116. Actuation system is described in further detail below in FIG. 7.

With continued reference to FIG. 1, commercial aircraft may further include a controller configured to control actuation system. Controller may include any computing device as described in this disclosure, including without limitation a microcontroller, microprocessor, digital signal processor (DSP) and/or system on a chip (SoC) as described in this disclosure. Controller may be configured to control actuation system. For example, controller may be in communication with actuation system by way of one or more networks, such as a controller area network. Controller may second a signal to actuation system in order to control actuation system. Controller will be discussed in greater detail below.

Folding wings 120 may further include a locking mechanism, wherein the locking mechanism is configured to secure wings 116 in a folded or extended position. Locking mechanism may be configured to prevent folding wings 116 from folding during takeoff, during flight and during a landing. Locking mechanism may also be referred to as a “lock”. Locking mechanism will be discussed in further detail below. Additional disclosure on aircraft structures may be found in U.S. patent application Ser. No. 17/502,428, filed on Oct. 15, 2021, and titled “SYSTEMS AND METHODS FOR FOLDING WINGS ON AN AIRCRAFT,” having attorney docket number 1179-050USU1, the entirety of which is incorporated by reference herein.

With continued reference to FIG. 1, commercial aircraft 100 includes a passenger cabin 124. Passenger cabin 124 is located within main body 108 and has a wide body passenger capacity. “Passenger cabin” as described in this disclosure is an area within main body 108 which passengers may be located and seated during a flight. Passenger cabin 124 may include passenger seats, passenger tables, aisles, passenger bathrooms, and the like. In some embodiments, passenger cabin 124 comprises more than two passenger aisles, wherein each passenger aisle may include one or more passenger seats on each side of the passenger aisle. In some embodiments, passenger cabin 124 may comprise more than two passenger aisles, wherein the more than two passenger aisles are parallel to each other. In some embodiments, passenger cabin 124 may include 3 or 4 aisles. Passenger cabin having 3 or 4 aisles may reduce waiting time when passengers are boarding and deboarding commercial aircraft 100. The aisles within passenger cabin 124 may be parallel to one another. Additionally, or alternatively, one or more passenger aisles may be perpendicular to one or more passenger aisles. In some embodiments, Passenger cabin 124 may be located in a lateral middle of main body 108. As used in this disclosure, a “lateral” direction of an aircraft may refer to a direction running from wing tip to wing tip. Lateral direction may be substantially orthogonal to a nose to tail direction. In some embodiments, passenger cabin 124 may include a seat row count wherein the seat row count is a maximum number of passenger seats within a given row. Passenger cabin 124 may further include a seat width wherein the seat width is a width of each passenger seat within passenger cabin 124. In some embodiments, seat row count and seat width may be substantially independent of a drag of the aircraft. For example, unlike tube and wing aircraft, that may contain a maximum seat row count (e.g. 12 seats on a commercial aircraft) due to drag concerns, BWB 104 may include a larger seat row count without issues of drag. Seat row count and seat width may be substantially independent of drag due to reduced wetted area when compared to tube and wing aircraft. Additionally, or alternatively, seat row count may be independent of a wing length. Unlike tube and wing aircraft, BWB 104 passenger cabin 124 and seat row count is not directly proportional to a wing length. For example, a BWB 104 having a large passenger cabin 124 may contain the same wing length of a BWB 104 having a smaller passenger cabin 124.

With continued reference to FIG. 1, passenger cabin 124 contains wide body passenger capacity. “Wide body passenger capacity” as described in this disclosure refers to a passenger capacity similar to the passenger capacity of a tube and wing commercial aircraft with a fuselage large enough to accommodate two or more passenger aisles, wherein wide body passenger capacity is subject to a plurality of cabin constraints. The passenger capacity of a tube and wing twin aisle tube and wing aircraft may contain a minimum of 200 passenger seats and a maximum of 800 passenger seats. In some embodiments, wide body passenger capacity may include a maximum passenger capacity of at least 200 passengers. In some embodiments, wide body passenger capacity may include a maximum passenger capacity of at least 300 passengers. “Plurality of cabin constraints” as defined in this disclosure are limitations to the number of seats, passengers, seat sizes, seats in a row and the like. Plurality of cabin constraints may include a wide body seat size. “Wide body seat size” as described herein refers to a passenger seat size of a tube and wing commercial wide body aircraft. For example, Wide body seat size may include seat dimensions similar to that of a Boeing 787 Dreamliner. Wide body seat size may include a seat width and seat pitch. Seat width as described herein refers to a range of width for a passenger seat. In some embodiments, seat width may contain a minimum seat width of 18 inches. Additionally, or alternatively, seat width may contain a minimum seat width of 16 inches. “Seat pitch” as described in this disclosure is the distance from any point on one seat to the same point on another seats. Seat pitch may contain a minimum seat pitch of 27 inches. Wide body seat size may further include an arm rest having an arm rest width. The arm rest width may contain a width of at least 2 inches. In some embodiments, seat pitch may contain a minimum seat pitch of between 30 and 35 inches. Plurality of cabin constraints may further include at least a single aisle. At least a single aisle may contain an aisle width of at least 15 inches. In some embodiments at least a single aisle may contain an aisle width of at least 20 inches. Plurality of cabin constraints may further contain a minimum or maximum packing efficiency. Packing efficiency will be described in greater detail below. Plurality of cabin constrains may contain a seat row amount wherein the seat row amount may contain a minimum or maximum number of seats per a given row. The seat row amount may be at least 2 seats per row. In some embodiments, the seat row amount may contain a maximum of 16 seats per row. Plurality of cabin constraints may further include a seat row limit wherein the seat row limit is the number of seats within a given row before it needs to be separated by an aisle. For example, a seat row limit of 2, would require a row of 8 seats to have at least 4 passenger aisles. In another nonlimiting example, a seat row limit of 4 would require a row of 8 seats to have at least one passenger aisle. In some cases, wide body passenger capacity may be function of regulatory, efficiency and/or market constraints.

With continued reference to FIG. 1, a wing length may be independent of a passenger capacity, where independence signifies that wing length does not vary with passenger capacity within a given range. The given range may include a minimum range of between 200 and 350 passengers. “Wing length” as described herein refers to the length of wing 116 extending from a wing tip until transition 112 and/or main body 108. Wing length may be independent of passenger capacity such that BWB 104 having a maximum capacity of 350 passengers may include a substantially similar wing length as a BWB 104 having a maximum capacity of 200 passengers. In addition, Wing length may be independent of a size of main body 108. In some embodiments, wing length is independent of wide body passenger capacity. Unlike tube and wing aircraft in which wing length is directly proportional to fuselage size, wing length on BWB 104 may be independent of a fuselage size, a passenger capacity and/or main body 108 size within a given range of values.

In some embodiments, passenger cabin 124 may include a single passenger aisle. The single passenger aisle may extend laterally along passenger cabin 124. In some embodiments, passenger cabin 124 may include two or more passenger aisles. Two or more passenger aisles may be substantially parallel with one another. Two or more passenger aisles may also intersect at right angles. Passenger cabin 124 may include seats, wherein each seat is designated for an individual passenger. Seats may contain a reclining seat, a leather seat, a cloth seat, or any seat suitable for aircraft travel. Seats may be arranged in a row wherein a plurality of seats are arranged in a single row. In some embodiments, passenger cabin 124 may include a plurality of rows wherein each row contains plurality of seats. In some embodiments, passenger cabin 124 may include the single passenger aisle along a lateral middle of passenger cabin 124 such that the arrangement of passenger seats is symmetrical on a left side of the passenger cabin 124 and a right side of passenger cabin 124. A “lateral” direction of an aircraft may refer to a direction running from wing tip to wing tip. Lateral direction may be substantially orthogonal to a nose to tail direction. A lateral middle may refer to the middle of the passenger cabin 124 wherein the middle is equidistant or substantially equidistant from wing 116. In some embodiments, passenger cabin 124 may include a substantially similar seat size wherein each seat is substantially similar in size. In some embodiments, passenger cabin 124 may include seats of different dimensions. Passenger cabin 124 may further include passenger bathrooms. Passenger bathroom may be placed at a front end of passenger cabin 124 and a rear end of passenger cabin 124. In some embodiments, passenger bathroom may be located in a middle of passenger cabin 124 between the front end and rear end. In some embodiments, passenger cabin 124 may include a singular passenger bathroom. In some embodiments, passenger cabin 124 may include a plurality of passenger bathroom located at a single end of passenger cabin 124.

With continued reference to FIG. 1, passenger cabin 124 may include a descending layout. “Descending layout” as described in this disclosure is an arrangement of seats in passenger cabin 124 wherein a number of seats within a first row contains the same or more seats than a second row. For example, a descending layout may include 8 seats in a first row, 6 seats in a second row and 4 seats in a third row. In another non limiting example, descending layout may include 8 seats in a first row, 8 seats in a second row and 6 seats in a third row. In some embodiments, passenger cabin 124 may be descending in shape wherein a rear portion of passenger cabin 124 is wider than a front portion of passenger cabin 124. In some embodiments, a portion of passenger cabin 124 may include a descending layout. In some cases, passenger cabin 124 may include an ascending layout. “Ascending layout” as described in this disclosure is an arrangement of seats in passenger cabin 124 wherein a number of seats within a first row contains the same or fewer seats than a second row. For example, an ascending layout may include 8 seats in a first row, 10 seats in a second row and 12 seats in a third row. In another non limiting example, ascending layout may include 8 seats in a first row, 8 seats in a second row and 10 seats in a third row. In some embodiments, passenger cabin 124 may be ascending in shape wherein a rear portion of passenger cabin 124 is wider than a front portion of passenger cabin 124. In some embodiments, a portion of passenger cabin 124 may include a ascending layout.

With continued reference to FIG. 1, passenger cabin 124 may contain a packing efficiency having a maximum of about 0.83. “Packing efficiency” as described in this disclosure is a calculation wherein a total number of seats in a row is divided by the number of seats and aisles in a row. For example, an aircraft having 9 total seats in a row and two aisle seats will contain a packing efficiency of 9/(9+2)=0.82. Packing efficiency is increased when the total number of seats in a row are increased. Packing efficiency is decreased when the number of aisles are decreased. As opposed to tube and wing aircraft that may be constrained to two aisles due to size constraints, BWB 104 may include multiple aisles wherein the packing efficiency of BWB 104 is lowered. In some cases, passenger cabin may include a packing efficiency having a maximum of 0.80. Additionally, or alternatively, passenger cabin 124 may contain a packing efficiency of at least 0.90. For example, passenger cabin 124 may contain 18 seats within a single passenger row wherein the packing efficiency is 0.947. As opposed to tube and wing aircraft, BWB 104 may contain more than 15 seats in a row without imposing regulatory or efficiency issues. Regulatory issues may include issues relating to a maximum width of the aircraft, a maximum height of the aircraft or any other regulatory issues that may be imposed by a governmental agency. Efficiency issues as described in this disclosure may include issues relating to increased fuel usage, increased cost, increased weight and the like. In some embodiments, packing efficiency may further be calculated as the total length of the passenger seats divided by the total length of the passenger seats and the aisle length. For example, an aircraft may contain two passenger aisles each totaling 19 inches and 7 passenger seats having a total length 146 inches wherein the packing efficiency will be calculated as 146/(146+19+19)=0.793. In contrast, the packing efficiency calculated above may be calculated as 7/(7+2)=0.777

With continued reference to FIG. 1, passenger cabin 124 may include at least one passenger row having 12 or more passenger seats. The 12 seats in at least one passenger row may be placed equidistant from each other. In some embodiments, at least one passenger row includes single passenger aisle, wherein 6 passenger seats are located on one side of single passenger aisle and 6 seats are located on another side of single passenger aisle. At least one passenger row may further contain more than 12 seats. In some embodiments, the at least one passenger may contain 16 seats wherein the 16 seats are separated by 4 passenger aisles. In some embodiments the at least one passenger row may include a plurality of passenger aisles.

With continued reference to FIG. 1, passenger cabin 124 may include a single deck, with cargo and passengers each substantially located on or above the single deck. As used in this disclosure, a “deck” on an aircraft is platform upon which one or more of passengers and cargo may be stored. A single deck may be contrasted with a two-deck configuration analogously to a single-story building contrasted to a two-story building. Single deck may include a deck with various heights differentials. For example, single deck may include a step wherein a portion of passenger cabin 124 is slightly elevated in comparison to another portion of passenger cabin 124. Single deck may further include a cargo store. A “cargo store” is a location in which cargo can be held. For example, cargo store may include the baggage of passengers on the aircraft. Cargo store may be located within passenger cabin 124 such as above passenger seats. Cargo store may also be located lateral to passenger cabin 124. In some cases, cargo store may be located within a wing portion of BWB 104.

With continued reference to FIG. 1, passenger cabin 124 may include more than one cabin bays. “Cabin bay” as described in this disclosure refers to a specific compartment within passenger cabin 124 that may be used to transport passengers. Passenger cabin 124 may include more than one cabin bays wherein each cabin may refer to a specific portion of passenger cabin 124. The more than one cabin bays may be separated by a wall, wherein the wall separated the one or more cabin bays into separate compartments. Additionally, or alternatively, the seat size in one cabin may differ from the seat size of another cabin bay. In some embodiments, one cabin may contain a different quantity of passenger seats. In some embodiments, wall of cabin bay may include windows wherein passenger in one cabin bay may interact with passengers of another cabin may. In some embodiments, a first cabin bay may be located in a front of passenger cabin 124, while a second cabin may be located in a rear of passenger cabin 124. In some embodiments, a wall may extend laterally along passenger cabin 124 such that the more than one cabin bays are located on a right and left side of passenger cabin 124.

With continued reference to FIG. 1, in some embodiments passenger cabin 124 may contain more than one forward entry doors. “Forward entry door” as described herein refers to doors on a commercial aircraft that are utilized for passenger entry and exit during the course of a routine flight. In some embodiments, the more than one forward entry doors are located on opposites sides of main body 108. “Opposite sides” as discussed herein refers to a left side and right side of main body 108. For example, one of the more than one forward entry doors may be located on a left side of main body and one of the more than one forward entry doors may be located on a right side of main body. In some embodiments, the more than one forward entry doors may be located on transition 112. In some embodiments, a plurality of forward entry doors may be placed on commercial aircraft such that a location of plurality of forward entry doors are symmetrical about an axis.

With continued reference to FIG. 1, passenger cabin 124 or alternatively commercial aircraft 100 may be configured for short range flight. Short range flight is described in further detail in this disclosure. Passenger cabin 124 may be configured for short range flight such that passenger cabin 124 does not contain a crew rest area. As opposed to long range flights in which a crew rest area may be required for flight personnel to rest, passenger cabin 124 may not contain a crew rest due to the short distance commercial aircraft will be traveling 124. In addition, passenger cabin 124 may be configured for short range flight such that passenger cabin contains a maximum of one bathroom for every 40 passenger seats. Additionally or alternatively passenger cabin 124 may contain a maximum of one passenger bathroom for every 50 passenger seats. In some cases, passenger cabin includes a maximum of one passenger bathroom for every 80 passenger seats. As opposed to long-range flights, wherein a passenger cabin may contain at least one bathroom for every 30 or 40 passenger seats, commercial aircraft may contain one bathroom for every 80 passenger seats due to the decrease in need of bathrooms. In some embodiments, passenger cabin 124 may further be configured for short range flight such that passenger cabin includes a maximum of one galley. Additionally or alternatively, passenger cabin may include a maximum of two galleys. In some embodiments, passenger cabin 124 may be configured for short range flight wherein passenger cabin 124 does not contain a pilot rest area. In some cases, passenger cabin 124 configured for short-range flight may include commercial aircraft 100 having more densely packed seating arrangements. For example, economy class seats may be spaced more closely together in the longitudinal direction (reduced seat pitch). The reduced comfort level that results may be acceptable to passengers for short flight durations (in exchange for reduced ticket prices). Also, higher class seats such as business and first-class seats may also provide reduced amenities permissible due to the short flight duration. For example, seats that turn into beds may be unnecessary for flights of short duration. Seats of all classes may be narrower than they might be for longer flights for which comfort is more important. In some cases, passenger cabin may include the use of lightweight but less comfortable seats. Reduced weight increases fuel efficiency or may enable the airplane to carry more passengers. Lightweight seats may also employ thinner seat backs despite the reduction in comfort that results. Thinner seat backs may enable even tighter longitudinal seat spacing. Additionally, or alternatively, passenger cabin may include an all-economy arrangement that permits an increased number of passengers wherein every passenger seat contains similar accommodations. This increased number (and weight) of passengers may be enabled by the reduction in fuel weight afforded by short range flights. In some cases, commercial aircraft may include an increase in cabin doors. In some cases, passenger cabin 124 may contain 2 or more cabin doors. In some cases, passenger cabin 124 may include 4 or more passenger cabin doors. In some cases, passenger cabin may contain 6 cabin doors, wherein 3 cabin doors are located one side of commercial aircraft and 3 cabin doors are located on an opposite side of commercial aircraft 100. A high-density, all-economy airplane may carry far more passengers than the baseline mid or long-range airliner. Emergency egress regulations stipulate a maximum evacuation time. The high-density airplane may be unable to evacuate the airplane quickly enough. The evacuation rate is influenced by the number of available doors. More doors gives a faster rate. In some cases, two gates at an airport can service commercial aircraft 100 having doors located on either side of the aircraft. In some cases, commercial aircraft may be serviced my multiple jetways, wherein a first jetway may be located on one side of commercial aircraft and a second jetway is located on a another side of commercial aircraft. In some cases, a third or fourth jetway may be utilized to service the more than one entry doors located on commercial aircraft 100. For example, four jetways may be used wherein two jet ways are placed on either side of commercial aircraft, one in the front of commercial aircraft 100 and one located on the aft.

With continued reference to FIG. 1, passenger cabin 124 may include increased overhead bin compartments for passengers. As opposed to tube and wing aircraft that are limited to carry on baggage limits of 45-50 linear inches, commercial aircraft 100 may contain an overhead bin capacity of between 50 and 60 linear inches. “Linear inches” for the purposes of this disclosure is the sum of the length, width and height of an object. For example, an object having dimensions of 20×20×20 has a size of 60 linear inches. In some cases, passenger cabin 124 may allow for multiple carryon bags within a limit of 45-50 linear inches as opposed to tube and wing that may only allow for one. Due to the increased volume of a commercial aircraft 100 as opposed to tube and wing aircraft, commercial aircraft 100 may utilize more passenger cabin 124 space for overhead bins. Commercial Aircraft may be configured for short range flight such that passengers may store all bags within passenger cabin 124. This may favorably decrease turnaround times of a flight as crew do not need to a cargo store nor do passengers need to wait for their cargo at a baggage claim. Commercial aircraft 100 may be configured for short range flight such that cargo is located within passenger cabin 124. Additionally or alternatively, commercial aircraft may be configured for short range flight wherein passenger cabin contains an overhead bin space large enough to carry luggage sized at 65 linear inches. In some cases passenger cabin 124 may contain an overhead compartment large enough to hold a luggage of 80 linear inches. In some cases passenger aisles within passenger cabin 124 may contain 5 passenger seats per aisle, wherein one side of an aisle may contain three passenger seats whereas another side of passenger aisle may contain two passenger seats. As opposed to tube and wing aircrafts that contain at least 3 seats on either side of the aisle, a reduced seat count within each aisle may allow for more linear inches of bag storage per passenger along the aisle. For example, two airplanes may have 32-inch seat spacing with bag storage on both sides of the cabin. A six-across airplane has a linear storage length of 32″× 2/6 passengers=10.7 inches/passenger. A five across airplane may provide 12.8 inches/passengers, a favorable increment. As a result, commercial aircraft may allow for a bin capacity of 50-60 linear inches per passenger. Additionally or alternatively, passenger cabin 124 may be rectangular in cross section whereas a tube-and-wing aircraft may be approximately circular. A passenger cabin 124 storage area may provide increased volume outboard and above the volume within a circle of similar width. This may enable the passenger cabin 124 bag storage volume to accept roll-aboard bags oriented on edge as opposed to flat. A typical carry-on bag may have dimensions of 22×14×9 inches. In both the tube-and-wing and commercial aircraft 100, the bags may be oriented with the 22″ dimension laterally. The tube and wing storage accepts bags with the 14″ dimension oriented longitudinally. This means that each passenger (from example above) may carry only 10.7/14=0.76 bag. In contrast, a 3+2 arrangement within passenger cabin 124 may carry bags on edge, with the 9″ dimension oriented longitudinally. This provides 12.8/9=1.42 bag/passenger, almost twice as much as the tube and wing.

With continued reference to FIG. 1, commercial aircraft 100 includes at least a propulsor 128. At least a propulsor 128 is attached to a portion of main body 108 and configured to propel BWB 104 through air. At least a propulsor 128 may include an electric motor, a jet engine, propellers, turboprop engines, turbojet engines, turboshaft engines, fuel cell driven motors, piston driven engines, and the like. At least a propulsor 128 may include an additional propulsor or alternatively a plurality of propulsors, wherein each at least a propulsor 128 works individually or in tandem to provide thrust, life or counteract any forces acting on aircraft. at least a propulsor 128 may be powered by fuel such as jet fuel, a battery powering a propeller, gasoline-based fuels, diesel-based fuels hydrogen fuel, fuel cells and the like. At least a propulsor 128 may be attached to an aft surface of commercial aircraft 100. In some embodiments, at least a propulsor 128 may be mounted and mechanically fastened onto an upper aft surface of main body 108.

With continued reference to FIG. 1, mounting propulsor 128 onto an upper aft surface of main body 108 may aid in noise reduction of commercial aircraft 100. A considerable amount of noise generated by an aircraft may be due to the noise of the propulsors of an aircraft. It is advantageous to place engines above and away from the ground in order to dissipate noise up and into the atmosphere as opposed to surrounding areas. In a tube and wing aircraft, propulsors are located on a lower surface of the aircraft wing wherein the noise is dissipated to lower surrounding areas. This noise may also be referred to as “ground noise”. This may be disadvantageous to surrounding communities around airports who receive the ground noise. In some cases, main body 108 may allow for shielding of directly-radiated engine noise between commercial aircraft and the ground 100. Particularly, mounting of propulsor 128 on the top of the aft portion of main body 108 may allow for shielding of engine noise. In addition, the positioning of propulsor 128 may allow for engine noise to be reflected upwards and away from the ground. In contrast, engine noise and especially the jet noise just described is reflected by the lower wing surface and to some extent the fuselage side and bottom. This compounds the noise transmitted by a tube-and-wing to the community below. Further, larger tube and wing aircraft may not be able to land into smaller airports due to noise regulations. By placing propulsors on an upper surface of commercial aircraft 100, noise is dissipated into the upper surrounding atmosphere as opposed to lower surrounding atmosphere. In addition, main body 108 of commercial aircraft 100 may shield noise from lower surrounding areas. In addition commercial aircraft may contain noise dissipating material surrounding propulsor 128 such that noise from propulsor may be absorbed by the noise dissipating material. This may be contrasted to tube and wing aircraft that contain propulsors on a lower surface of the aircraft wing and therefore cannot shield ground noise from the propulsors. The placement of propulsors 128 on commercial aircraft 100 allow commercial aircraft 100 to fly into and out of airports that have increased noise regulations. In addition, an absence of slotted slats and flaps on wings of commercial aircraft 100 may reduce local aerodynamic flow speed and separation, thereby reducing aerodynamic noise associated with commercial aircraft 100. Local flow speeds in the vicinity of the slots may be very high, resulting in turbulence and noise. In some flight modes, this noise may be a big contributor to the noise signature. In contrast, as opposed to tube and wing aircraft, commercial aircraft 100 may not contain slotted surfaces, substantially reducing noise from the airframe. Aircraft noise may arise due to airflow around an aircraft main body and the control surfaces. By reducing control surfaces such as slotted slats and flaps on an aircraft wing, aircraft noise may be minimized. When lift devices such as slotted slats and flaps are moved or lowered, aircraft noise increases. Commercial aircraft 100 may be configured to smaller airports having noise regulations by placing propulsor 128 on an upper aft surface of commercial aircraft. Additionally or alternatively, commercial aircraft may be configured for smaller airports by removing the need for slotted slats and flaps. In some cases, landing gear on a tube and wing aircraft may increase noise due to flow separation around components designed for non-aerodynamic purposes. Flow separation results in turbulence, which may cause noise. By reducing slotted slats and mounting propulsor 128 onto an upper aft surface, commercial aircraft 100 may contain an overall reduced noise.

With continued reference to FIG. 1, propulsor 128 may be configured for short range flight. Propulsor 128 may be configured for short range flight such that a propulsor with reduced thrust rating is used. As opposed to tube and wing aircraft, wherein a Mach number 0.72-0.80 is desired for the highest lift to drag ratio, blended wing body aircraft may contain its highest lift to drag ratio at lower speeds. For example, blended wing body aircraft can travel at slower speeds while still maintain an optimal lift to drag ratio. As a result, a lighter engine may be used to thrust commercial aircraft 100. In some cases, propulsor may include a low thrust propulsor, such as a propulsor having a maximum speed of Mach 0.70. A lower maximum speed may be beneficial as the engine may be lighter as compared to an engine having larger thrust and larger maximum speed. In some cases, a short-range flight may allow for a reduced maximum gross weight in comparison to a long-range model due to reductions in gauge and fuel volume. As a result, thrust may be reduced to the decrease in maximum gross weight. In addition propulsor 128 may be configured for short range flight such that propulsor may be configured for flight at reduced speeds and lower altitudes. For example, in some short flights an aircraft may climb enroute for the first portion of the flight and descend enroute for the second portion, without ever reaching an optimal cruise altitude and leveling off. Further, operation at lower Mach number may tend to favor flight at a lower altitude. Importantly, optimal engine thrust generally tends to decline with increased altitude and airspeed. Some aircraft propulsors may be sized to achieve a combination of high altitude and airspeed at a selected airplane weight. If the weight, altitude, and/or airspeed are reduced, it may be that a smaller, lighter engine may be used. Alternatively, a larger, heavier engine may be used at a lower throttle setting, increasing engine life, and decreasing engine maintenance.

With continued reference to FIG. 1, commercial aircraft 100 includes a fuel storage 132. “Fuel storage” as described in this disclosure is a compartment within BWB 104 configured to hold fuel used to propel BWB 104. In some embodiments fuel storage 132 may be located within wing 116. In some embodiments, wing 116 contain a cavity wherein fuel storage 132 may be located and stored. In some embodiments, fuel storage 132 may be independent of a passenger capacity, where independence signifies that fuel storage 132 does not vary with passenger capacity within a given range. For example, fuel storage 132 of an aircraft having a maximum capacity of 500 passengers may be similar to fuel storage 132 of an aircraft having a maximum capacity of 50 passengers. In some embodiments fuel storage may be independent of a passenger capacity ranging from 150-300 passengers. In some embodiments, fuel storage 132 may be independent of a size of main body 108. In tube and wing aircraft, fuel storage 132 is dependent on the size of the fuselage. For example, a smaller fuselage may require smaller wing 116 and therefore less fuel may be stored within wing 116. In some embodiments, fuel storage 132 may be independent of wide body passenger capacity.

With continued reference to FIG. 1, fuel storage 132 may be stored within transition 112. “Transition” as described in this disclosure refers to a section of BWB 104 between main body 108 and wing 116. Transition 112 may be located between main body 108 and wing 116. In some embodiments, transition 112 may increase in chord and thickness from wing 116 in a direction of main body 108. Fuel storage 132 may be located within transition 112 wherein fuel storage 132 is located within a cavity located in the increased chord and thickness. In some embodiments, fuel storage 132 may be located within in a portion of transition 112 and/or a portion of wings 116. In some embodiments fuel storage 132 may be larger than a fuel storage 132 of a tube and wing aircraft due to the increased chord and thickness of transition 112. In some embodiments, fuel storage 132 may be stored within a nose section of commercial aircraft 100. In one or more embodiments, placement of fuel storage 132 within the nose section of commercial aircraft may allow for alignment of longitudinal center of gravity along commercial aircraft. In one or more embodiments, placement of fuel storage 132 may allow for manipulation of a center of gravity of commercial aircraft by allowing for fuel to flow to and/or from the nose portion of commercial aircraft. In an embodiment, fuel storage 132 may be located aft of commercial aircraft 100, within one or more transitions 112 and/or within nose portion of commercial aircraft wherein fuel may be rerouted along commercial aircraft 100 in order to allow for stabilization of commercial aircraft through the manipulation of the center of gravity of commercial aircraft 100. In one or more embodiments, commercial aircraft may contain one or more fuel valves in order to allow for the flow of fuel between one or more fuel storages located on commercial aircraft. In one or more embodiments, the one or more fuel valves may include but is not limited to, cone-type valves, gate valves, and/or poppet type valves. In one or more embodiments, commercial aircraft 100 may contain one or more mechanical and/or electromechanical valves wherein actuation of the one or more valves may allow for fuel to flow from one fuel storage 132 to another. In one or more embodiments, each fuel storage may contain a sensor configured to sense an amount of fuel within each fuel storage. The sensor may include any sensor as described in this disclosure. In one or more embodiments, the sensor may further include a pressure sensor, a humidity sensor, capacitive probes and/or any other sensor that may be used to determine a fuel amount within fuel storage 132. In one or more embodiments, a computing device such as any computing device and/or computing system as described in this disclosure may be configured to receive a fuel amount within each fuel storage. In one or more embodiments, computing device may be configured to actuate one or more mechanical valves in order to allow for fuel to flow between one or more fuel storages 132. In one or more embodiments, computing device may be configured to generate a particular center of gravity wherein computing device may allow for fuel to flow between fuel storages until the center of gravity is located at a particular point on commercial aircraft 100. In one or more embodiments, commercial aircraft may further contain one or more mechanical and/or electromechanical pumps in order to facilitate the flow of fuel between one or more fuel storages 132.

With continued reference to FIG. 1, fuel storage 132 contains a fuel capacity, the fuel capacity configured for short range flight. “Fuel capacity” as described in this disclosure refers to a quantity of fuel that can be stored in fuel storage 132. Fuel capacity may be represented as an overall fuel capacity wherein the overall fuel capacity is quantified in liters, pounds, kilograms, gallons or the like. Fuel capacity may further be represented as a fuel capacity per passenger wherein the fuel capacity per passenger is an overall fuel capacity divided by the maximum number of passengers within passenger cabin 124. For example, an aircraft having a total fuel capacity of 1000 pounds and a maximum number of passengers of 10 will have a 100 pounds fuel capacity per passenger. Fuel capacity may include a maximum fuel capacity of between 200 pounds and 300 pounds of fuel per passenger. In some embodiments, fuel capacity contains a maximum fuel capacity of 200 pounds of fuel per passenger. In some embodiments, fuel capacity is independent of a wingspan of main body 108 where independence signifies that fuel capacity does not vary with wingspan size within a given range. For example, fuel capacity of a BWB 104 having a wingspan of 48 meters similar to that of a Boeing 732-ER may contain the same fuel capacity as a BWB having a wingspan of 36 meters similar to that of a Boeing 732. “Wingspan” as described herein refers to the length of wings from one winglet to a second winglet. In some embodiment fuel capacity is independent of wingspan of main body 108 within a range of between 150 and 400 passengers. In some embodiments, fuel capacity may be independent of a size of main body 108 such that fuel capacity may stay consistent even if a size of main body 108 increases or decreases. Additionally, or alternatively, if a maximum passenger capacity is increased within main body 108, fuel capacity may stay the same. In tube and wing aircraft, a size of aircraft wing 116 is proportional to the size of the fuselage. As a result, fuel storage 132 located within wing 116 is proportional to the fuselage. In a BWB 104, main body 108 may be independent of wing 116 size.

With continued reference to FIG. 1, fuel capacity is configured for short-range flight. “Short-range flight” as described in this disclosure is a maximum flight distance of 3000 nautical miles. For example, a flight from Los Angeles to New York having a distance of about nautical 2500 miles may be categorized as a short-range flight. Short-range flights may be suitable for domestic travel or flights within a closely defined area. Short-range flights may typically be utilized for business or for same day travel wherein a passenger can arrive at a destination within the same day they left. Short-range flight may further include flights that are capable of traveling to and from a particular location multiple times within a single day. For example, a passenger aboard a flight from Los Angeles to San Francisco having a flight time of approximately 1 hour, can travel back from San Francisco to Los Angeles in a single day. Additionally, and continuing the example, the passenger may board the same flight again and return within the same day. Short-range flight may include a maximum flight duration of 6.5 hours. Fuel capacity may be configured for short-range flight such that fuel capacity contains a maximum fuel capacity of 14,000 gallons. Additionally, or alternatively, fuel capacity may be configured for short range flight such that fuel capacity contains enough fuel for a maximum flight distance of 3000 nautical miles. Additionally, or alternatively, fuel capacity may be configured for short range flight wherein fuel capacity contains a maximum fuel capacity for a flight duration of 6.5 hours. In some embodiments, fuel capacity is configured for short-range flight such that fuel capacity contains a maximum fuel capacity of 300 pounds of fuel per passenger. Additionally, or alternatively, fuel capacity may contain a maximum fuel capacity of 200 pounds of fuel per passenger. Additionally, or alternatively, fuel capacity contains a maximum fuel capacity of 150 pounds of fuel per passenger. In some cases, commercial aircraft 100 may be similar to that of a long-range aircraft wherein commercial aircraft contains a maximum fuel capacity of 8000 miles, however commercial aircraft 100 may contain a limiter that limits the amount of fuel commercial aircraft may carry. “Limiter” as described herein refers to a component capable of limiting the amount of fuel that can be stored in fuel storage. Limiter may include a sensor wherein the sensor indicate that fuel storage is “full” for a short-range flight. Sensor may determine a specific fuel capacity for short-range flight wherein once the fuel capacity is reached, sensor may notify an operator that fuel storage is full. In some cases, sensor may notify or indicate to an aircraft operator that commercial aircraft 100 cannot exceed a predetermined fuel level due to the aircraft's short-range capabilities. A short-range aircraft may contain lighter materials that are not capable of holding enough fuel for a long-range flight. While commercial aircraft 100 may have the availability to store more fuel, commercial aircraft 100 may not contain the required structural components to hold more fuel. In some cases, sensor may include a float arm similar to that of a gas-powered car, wherein the change in resistance in the float arm may indicate a particular fuel level of commercial aircraft 100. A predetermined resistance may indicate that commercial aircraft 100 is full for a short-range flight. Limiter may further contain partitions that limit the volume within a BWB such that the fuel storage contains a fuel capacity configured for short range flight. In some cases, configuring fuel capacity for short-range flight might include placing less fuel within fuel storage. A short-range flight does not require a full fuel tank and therefore commercial aircraft 100 can have a larger fuel storage that does not need to be filled. In some embodiments, short distance flight may refer to a domestic flight wherein the origin and the destination are located within the same country.

With continued reference to FIG. 1, commercial aircraft 100 contains a landing gear 140 located on an undercarriage of BWB 104 wherein landing gear 140 is configured for short range flight. “Landing gear” as described herein refers to the components of an aircraft that supports and controls an aircraft when an aircraft is taking off, landing or parked. For example, landing gear 140 may include an aircraft wheel wherein the aircraft wheel may be used to move the flight aircraft while the aircraft is on ground. Landing gear 140 may include aircraft wheels, aircraft brakes, landing struts, shock absorbers, retractable gear, and the like. Configuring landing gear 140 for short range flight may include configuring landing gear 140 to support a commercial aircraft having a lighter weight. In some embodiments, landing gear configured for short-range flights may include landing gear smaller in gauge than landing gear configured for long-range flights. In some embodiments, commercial aircraft 100 configured for short-range flight may contain less weight than a similar aircraft configured for long range travel due to a decrease in fuel capacity and a resulting decrease in weight. Landing gear 140 may include a plurality of aircraft wheels. In some embodiments, configuring landing gear 140 for short range flight may include having a maximum of 10 aircraft wheels. In some embodiments, plurality of aircraft wheels may contain a similar number of aircraft wheels to that of a narrow body aircraft. For example, a narrow body aircraft such as a Boeing 732 contains 6 aircraft wheels. In some embodiments, landing gear 140 may be configured for short range-range flight wherein plurality of aircraft wheels may include a minimum wheel diameter of 27 inches. Additionally, or alternatively, plurality of aircraft wheels may include a maximum wheel diameter of 45 inches. Additionally, or alternatively a plurality of aircraft wheels may include a maximum wheel diameter of 50 inches. In some embodiments, configuring landing gear for short-range flight may include configuring landing gear to have twin wheel main landing legs, wherein the main landing legs consist of two aircraft wheels. In contrast, configuring landing gear for long-range flight may include configuring landing gear to have a multiple axle main leg wherein the multiple axle main leg may contain 4 aircraft wheels. Configuring landing gear 140 for short-range flight May further include configuring landing gear 140 to have less than 4 hydraulic systems. Unlike tube and wing wide body long range aircraft that may contain 4 hydraulic systems, commercial aircraft 100 may contain less than 4 hydraulic systems similar to that of a tube and wing narrow body aircraft. “Hydraulic systems” as described herein are devices utilizing pressurized hydraulic fluid to actuate linkages and raise or lower landing gear 140. Landing gear 140 may be raised or lowered form a cargo store wherein landing gear is raised into cargo store after takeoff of commercial aircraft and lowered prior to landing of commercial aircraft. Configuring landing gear 140 for short-range flight may further include landing gear 140 having short-range aircraft brakes. Short range aircraft brakes may provide reduced capacity in accordance with reduced aircraft weight and speeds. Capacity may be reduced with a reduction of brake disk number or diameter. Variations in brake disk material may also affect braking capacity. A reduction in braking capacity may provide the airplane a favorable reduction in brake system weight or cost. For example, it may be that an aircraft may include steel brakes instead of more expensive carbon-carbon brakes due to the aircraft's short-range capabilities. In some cases, tube-and-wing airliners may use main and nose landing gears that include an integrated shock absorber and spring system. The landing gear leg includes a telescoping component that connects to the wheels (possibly by an intermediate truck). This component functions as a piston within a cylinder formed in the primary landing gear strut. Spring action may be provided by compressed gas in the upper portion of the cylinder. Damping may be provided by fluid in the lower portion of the cylinder being forced through one or more orifices during piston motion. In some embodiments, a pin is attached to the piston that passes through this orifice. This pin may vary in diameter along its length to provide a selected degree of damping over the piston's range of motion. This may be called a “metering pin.” Due to the cost of landing gear components, tube and wing aircraft generally contain similar landing gear components regardless of the weight of the aircraft. In some instances, additional material may be machined away to reduce weight and strength, however the diameter (gauge) of the piston (shock absorber) may not be changed for a lighter or shorter distance aircraft. In some instances, the profile of the metering pin is changed so that desired damping forces are still provided. In contrast, and in some embodiments, commercial aircraft 100 may include a swing arm system with a separate oleo wherein the piston is not fixedly integrated into the landing gear and instead a separate component that may be removed. As a result, the shock absorber may be swapped for one of a smaller diameter, thereby reducing the weight of the commercial aircraft 100. In some cases, the brakes may have a different metering needle to provide tailored dampening characteristics. Short-range aircraft brakes may include single disc brakes. Short range aircraft brakes may further include dual disc brakes, multiple disc brakes, and segmented rotor breaks. In some embodiment, configuring landing gear 140 for short-range flight may include landing gear 140 having short-range shock absorbers. Short-range shock absorbers may include oleo-pneumatic shock absorbers configured for narrow body aircraft and hydraulic springs struts configured for narrow body aircraft. In some embodiments, short range shock absorbers are shock absorbers configured for narrow body aircraft wherein the shock absorbers configured for narrow body aircraft are smaller in gauge than shock absorbers for wide body aircraft. In some cases, commercial aircraft 100 may include landing gear configured for smaller airports, such as airports with runways of a maximum of 5000 ft. Additional disclosure relating to landing gear may be found in Non-provisional application Ser. No. 17/958,779 filed on Oct. 3, 2022 and entitled “AN AIRCRAFT WITH OUTBOARD-STOWED LANDING GEAR” having attorney docker number 1179-070USU1, the entirety of each of which is incorporated herein by reference. Additional disclosure on landing gear systems may further be found in U.S. patent application Ser. No. 15/198,611, filed on Jun. 30, 2016, and titled “TILTING LANDING GEAR SYSTEMS AND METHODS,” having attorney docker number 1179-002USU1 the entirety of which is incorporated by reference. Additional disclosure on landing gear systems may further be found in U.S. patent application Ser. No. 17/870,365, filed on Jul. 21, 2022, and titled “NON-COUPLED LANDING GEAR APPARATUS AND METHODS OF USE,” having attorney docker number 1179-068USU1 the entirety of which is incorporated by reference.

With continued reference to FIG. 1, commercial aircraft 100 may further include a structural element. “Structural element” as described in this disclosure is a weight bearing support that is configured to resist pressurization loads of main body 108 and reduce skin bending loads. In some embodiments, structural element may include struts, beams, formers, stringers, longerons, interstitials, ribs, structural skin, straps, spars, or panels, and the like. Structural element may also include pillars. Structural element may also consist of a wall extending along passenger cabin 124 such that the wall separates passenger cabin 124 into multiple cabin compartments. Structural element may further extend along a passenger aisle wherein structural element extends substantially along the passenger aisle. Structural element may extend vertically from a lower surface of main body 108 toward an upper surface of main body 108. Structural element may also extend laterally or longitudinally along passenger cabin 124. Structural element may be made of aluminum, carbon fiber or a similar material suitable for aircraft or high-pressure environments requiring lighter materials. In some embodiments, structural element may contain a wall, wherein the structural element splits passenger cabin 124 into multiple cabin bays. In some embodiments, structural element is configured to contain a pressure vessel. “Pressure vessel” as described in this disclosure is a closed container designed to hold gasses at a pressure substantially different than that of the surrounding atmosphere. Pressure vessel in this disclosure may refer to main body 108 wherein main body 108 is designed to hold a gas, such as air within main body 108 at a pressure substantially different than the surrounding atmosphere. Pressure may be substantially different when commercial aircraft 100 is flying at high altitudes. Structural element may be configured to contain pressure vessel such that pressure vessel does not crush under a high-pressure differential. Structural element may further be configured to contain a pressure vessel such that structural element may prevent a balancing of pressure vessel with the ambient atmosphere. In some embodiments, structural element may be configured to prevent “core crushing”. “Core crushing” as defined in this disclosure is the process in which a vessel, primarily a hollow vessel, is crushed. In some embodiments, structural element 120 may extend from a first distal end of passenger cabin towards a second distal end of passenger cabin. In some embodiments, core crushing may refer to the collapse of a panel, such as without limitation a sandwich panel core, when the panel is flexed in bending. When flexed, a panel may be curved. An inner surface of panel may be concave and an outer surface of the panel may be convex. Inner surface may be under compression and may tend to push outwards. Outer surface may be under tension and may tend to pull inwards. Opposing forces of outer surface and inner surface may tend to crush material, e.g., core, holding them apart. Additionally, core crushing may be used more broadly to describe forces, for example, forces exerted by upper and lower wing skins on a supporting structure between them. In some cases, an airliner wing may operate with an upper and lower skin supported by front and rear spar webs and transverse ribs. When wing is flexed, the skins may tend to crush the spar webs and ribs; this may be considered a form of core crushing. In some cases, structural element may be configured to prevent pressure forces within main body from acting on main body in a direction outward of main body. Pressure vessels in aircraft are generally under pressure from within. As a result, pressure forces tend to act outward of main body. For example, the cabin of a BWB may be pressurized such that is it under greater pressure inside than outside. Structural element may be configured to prevent main body from expanding such that structural element is in tension.

With continued reference to FIG. 1, commercial aircraft 100 may be configured for short range flight such that commercial aircraft includes a lightened airframe, lightened landing gear and lightened engines. Commercial aircraft may be configured for short range flight by reducing the amount of fuel within fuel storage 132, commercial aircraft may utilize lighter structural elements for short range flight. In some cases, commercial aircraft 100 contains a similar fuel capacity as a long-range aircraft, however, a reduced amount of fuel is placed within fuel storage 132. As a result, lighter landing gear, lighter engines and a lighter airframe may be used due to the reduced weight. In some cases, commercial aircraft 100 may have a 10-20% reduction of airplane gross weight in comparison to a long-range aircraft due to the lighter structural components described above. In some cases, commercial aircraft 100 may be configured for short range flight by having a thinner aircraft frame as described above. In some cases, commercial aircraft may be configured for short range flight by reducing the amount of structural components within commercial aircraft as opposed to an aircraft configured for long-range flight. In some cases, commercial aircraft may include similar structural components to that of a narrow body tube and wing commercial. This may be contrasted to the structural components of a wide body tube and wing aircraft.

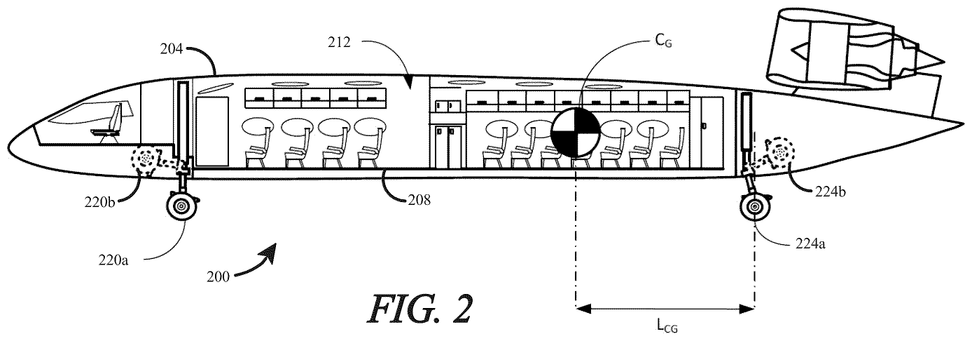

Referring now to FIG. 2, an exemplary aircraft 200 is illustrated in side-view. Aircraft 200 may include a blended wing body 204. Aircraft 200 may include a single deck 208. Single deck 208 may include a passenger compartment 212. As can be seen in FIG. 2, in some cases, nose gear 220a-b may be located substantially forward of single deck 208; and/or main gear 224a-b may be location substantially aftward of the single deck 208. In some cases, passenger compartment 212 may be located substantially between nose gear 220a-b and main gear 224a-b. FIG. 2 shows nose gear 220a-b in an extended position 220a as well as a retracted position 220b. FIG. 2 also shows main gear 224a-b in an extended position 224a as well as a retracted position 224b. As described above, in some cases, when retracted, one or more of nose gear 220b and main gear 224b may be located within a gear housing.

Continuing with reference to FIG. 2, a plane coincident with single deck 208 may be conceptualized as a horizontal line, coincident with the single deck 208, extending across the FIG. In some embodiments, one or more of nose gear 220a-b, main gear 224a-b, and gear housing may be located within a position that intersects or otherwise overlaps with plane coincident with single deck 208. Said another way, in some cases, at least a portion of one or more of nose gear 220a-b, main gear 224a-b, and gear housing may be at substantially a same height as single deck 208.

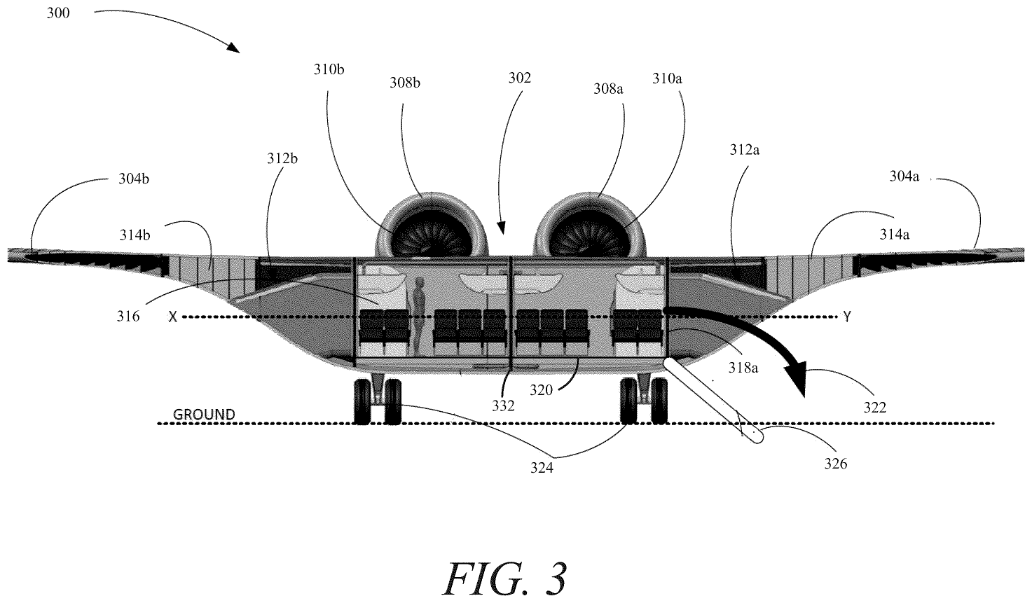

FIG. 3 is an exemplary front-view illustration of an exemplary aircraft 300. In some cases, aircraft may have a high wing geometry, as shown. Aircraft 300 may have a blended wing body 302. The blended wing body 302 may include a port wing 304a and a starboard wing 304b. Blended wing body 302 and wings 304a-b may have positive sweep angles. Aircraft 300 may further include a nacelle 308a that houses a port main engine 310a and a nacelle 308b that houses a starboard main engine 310b. Aircraft 300 may have a single deck 320.

With continued reference to FIG. 3, aircraft 300 may include a port cargo hold 312a and a starboard cargo hold 312b. In some examples, cargo holds 312 a-b are pressurized cargo holds designed to hold passenger cargo (suitcases and the like) as well as, in some examples, animal transport. Aircraft 300 may further include a port fuel tank 314a and starboard fuel tank 314b. It should be noted that the size and location of various structures, such as the cargo holds 312a-b, as well as the fuel tanks 314a-b are illustrated merely as an example, as other sizes, locations, and configurations may be used and are considered to be within the scope of the presently disclosed subject matter. Aircraft 300 may include a passenger compartment 316, which also may be referred to herein as a cabin 316.

With continued reference to FIG. 3, aircraft 300 may include an exit 318a, which may be used as an emergency egress route. Aircraft 300 may include other exits that are not illustrated in FIG. 3. As illustrated, Aircraft 300 may have a single deck 320 (i.e., single passenger and cargo floor). Further, aircraft 300 may have high wing geometry, as illustrated by wings 304a-b above centerline XY, which is approximately a center of height of aircraft 300 above a single deck 320 of the aircraft 300.

With continued reference to FIG. 3, in some cases, high wing geometry and location of exit 318a may increase a length of an exit tunnel significantly. Alternatively, with a low wing geometry where wings are at or near centerline XY, one or more of exits from aircraft may pass through at least a part of a wing of the aircraft. In some cases, a need to pass through a wing, for example with a low wing geometry, can increase a length of travel from a main cabin of aircraft to the outside, as the passenger needs to travel at least partially through the wing.

In FIG. 3, aircraft 300 has a high wing geometry, which in some examples significantly shortens length of travel from cabin 316 to outside, because passenger does not need to travel through wing, as it is above an egress path 322. Further, using a high wing geometry configuration, egress path 322 may be closer to ground. In some examples, with landing gear 324 up (raised or within blended wing body 302 of aircraft 300), egress path 322 may be near ground level. With landing gear 324 down (lowered or below blended wing body 302 of aircraft 300), egress path 322 may be 5 or 6 feet above the ground (i.e., height of the landing gear 324). In some examples, an exit door 326 may be configured to provide a ramp to assist passengers in exiting aircraft 300. Exit door 326, or another structure of aircraft 300, may also include an inflatable slide.

With continued reference to FIG. 3, aircraft may include a structural element 332. Structural element” as described in this disclosure is a weight bearing support that is configured to resist pressurization loads of blended wing body 302 and reduce skin bending loads. In some embodiments, structural element 3321 may include struts, beams, formers, stringers, longerons, interstitials, ribs, structural skin, straps, spars, or panels, to name a few. Structural element 332 may also include pillars. Structural element 332 may also consist of a wall extending along cabin 316. Structural element 332 may extend laterally or longitudinally along passenger cabin 316. Structural element 332 may be made of aluminum, carbon fiber or a similar material suitable for aircraft or high-pressure environments requiring lighter materials. Structural element 332 may include any structural element described in this disclosure.

Referring now to FIG. 3, in some cases, cargo holds 312a-b may be located only partially over single deck 320, for instance where aircraft 300 has a high wing geometry. In some cases, cargo holds 312a-b may be located on another deck, for instance substantially above single deck 320. In some cases, cargo holds 312a-b may have no deck (i.e., horizontal floor). For instance, in some embodiments, cargo holds 312a-b may have a non-horizontal deck which is at least partially defined by geometry of blended wing body 302. In some cases, cargo holds 312a-b may include storage systems, for instance shelving and/or cabinets to maximize volumetric storage efficiency. Volumetric storage efficiency may be determined as approximately a total volume of stored cargo divided by a total volume of cargo hold 312a-b. In some cases, cargo holds 312a-b are substantially outboard, i.e., laterally outward toward wings, of passenger compartment 316.

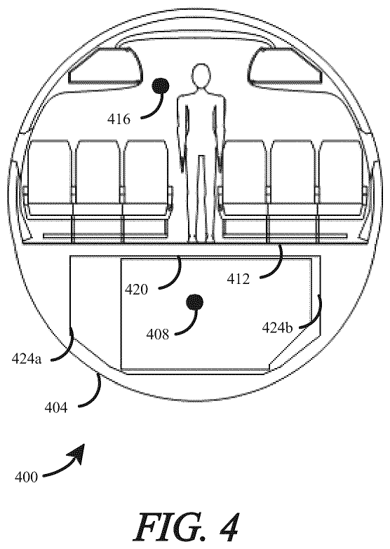

Referring now to FIG. 4, an exemplary front view of an exemplary tube and wing aircraft 400 is illustrated. Exemplary aircraft 400 may employ a tubular fuselage 404. Aircraft may locate cargo in a cargo hold 408 below floor (i.e., single deck) 412. In some cases, a passenger compartment 416 may be located atop single deck 412. In some cases, passengers ride within passenger compartment 416 in upper portion of fuselage. Typically, floor structure of tube-wing aircraft may be substantial. For example, floor 408 may consist of a series of transverse beams (“floor beams”) 420 supported at their outboard ends by tubular fuselage structure 404. In some cases, floor beams 420 may be supported by columns 424a-b, for instance just outboard of cargo bay 408. In some embodiments, columns 424a-b may transmit floor beam 420 loads to tubular fuselage 404 and may reduce floor beam weight by reducing a free span of the floor beams. Floor beams 420 may be surfaced by a combination of longitudinal elements, usually seat tracks, and floor panels that span between the seat tracks. In some embodiments, lateral elements, for example attached to a top of floor beams 420, support floor panels on their fore and aft edges. In some cases, passenger seat legs have a “button” that is captured within a slot in seat track. In some embodiments, fore-aft location of seats may be indexed and restrained by regularly spaced cutouts in the seat track. In some cases, seat tracks carry load of floor panels longitudinally to transverse floor beams 420. As a result, seat tracks may be shaped as I beams. In some embodiments, modern floor panels are generally a sandwich panel consisting of carbon-epoxy face sheets and a honeycomb core. In some cases, floor panel thickness may be about 0.400 inches. Floor panels may be fastened to seat tracks with screws through recessed inserts in the floor panel. In some embodiments, an upper surface of each floor panel may be flush with an upper surface of a seat track. In some cases, a lower surface of each floor panel may rest on lateral extensions of seat track. As a result, in some embodiments a smooth floor surface from wall-to-wall may be achieved, while allowing seat track slot access from above. In some cases, an aircraft having a blended wing body may preclude a dual deck arrangement as described in reference to FIG. 4 above, for instance in cases where the aircraft employs a single-deck configuration.

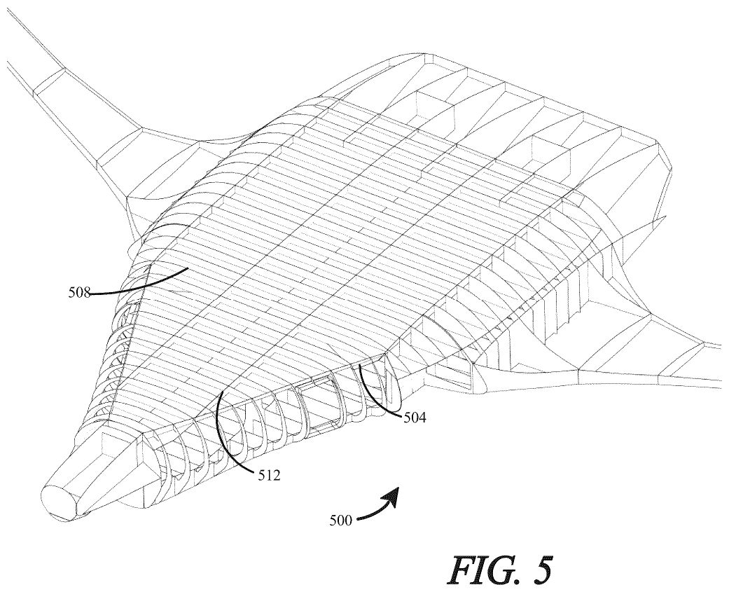

Referring now, to FIG. 5, an exemplary view showing a bottom of a blended wing body aircraft 500 is illustrated. In some embodiments, a BWB cannot practically use a dual deck cabin floor structure. In some cases, this may be because a BWB may have little depth between finished floor surface 504 (top of floor panel) and a lower outer mold line (OML) of BWB. Furthermore, in some cases, a dual deck floor structure may span between cabin walls, which may be supported by columns to an OML structure. As depth between floor and lower OML may be relatively small in a single-deck configuration, a dual deck floor structure may be likely to be very inefficient and heavy. In some embodiments, floor structure 504 of a BWB aircraft may support both a payload (multiplied by a maximum g-load) and a cabin pressurization load. In some cases, cabin pressure load may be far greater than payload weight. As a result, in some cases, floor structure 504, may resist far greater vertical loads.

With continued reference to FIG. 5, in some embodiments, OML structure and floor structure 504 may form an integrated structure. In this arrangement, floor structure 504 may function as a sandwich structure. For instance, a structural face of floor structure 504 may be considered an upper sandwich skin; and a lower OML may be considered a lower sandwich skin. In some cases, cabin and or cargo store walls may terminate lateral edges of sandwich structure and transfer their loads to airplane 500 as a whole. In some embodiments, transverse beams 508 may function as one or more of beams and/or shear webs, for instance by linking an upper sandwich skin (floor structure 504) and lower sandwich skin (lower OML). In some cases, additional longitudinal beams 512 may transmit shear longitudinally. FIG. 5 is provided by way of an example, it is likely that other embodiments, will include far more transverse elements 508 and longitudinal elements 512 than shown.

Still referring to FIG. 5, in some embodiments, structural skin may be preferably flat and without discontinuities, such as without limitations long grooves. A competing concern is seat tracks that may be necessary in any practical solution for a commercial airliner. In some cases, rather than being integral to floor 504 seat tracks may be fastened to the structural floor 504 and/or longitudinal elements 512, for instance between the floor 504 and lower OML. In some embodiments, upward protrusion of seat tracks may be “filled in” to provide smooth finished floor surface. In some cases, filling in seat track protrusions may be accomplished with a sandwich floor panel, as described with reference to FIG. 4. For example, one or more floor panels may be fastened to seat tracks or supported at one or more locations “in the field” so that the floor panel load is transferred to much-stronger integrated floor system 504.

Referring to FIG. 6, an exemplary blended wing aircraft 600 is illustrated. Aircraft 600 may include a blended wing body 604. For the purposes of this disclosure, a “blended wing body aircraft” is an aircraft having a blended wing body. As used in this disclosure, A “blended wing body” (BWB), also known as a “blended body” or a “hybrid wing body” (HWB), is a fixed-wing aircraft body having no clear or abrupt demarcation between wings and a main body of the aircraft along a leading edge of the aircraft. For example, a BWB 604 aircraft may have distinct wing and body structures, which are smoothly blended together with no clear dividing line or boundary feature between wing and fuselage. This contrasts with a flying wing, which has no distinct fuselage, and a lifting body, which has no distinct wings. A BWB 604 design may or may not be tailless. One potential advantage of a BWB 604 may be to reduce wetted area and any accompanying drag associated with a typical wing-body junction. In some cases, a BWB 604 may also have a wide airfoil-shaped body, allowing entire aircraft to generate lift and thereby facilitate reduction in size and/or drag of wings. In some cases, a BWB 604 may be understood as a hybrid shape that resembles a flying wing, but also incorporates features from tube and wing aircraft. In some cases, this combination may offer several advantages over tube-and-wing airframes. In some cases, a BWB airframe 604 may help to increase fuel economy and create larger payload (cargo or passenger) volumes within the BWB. BWB 604 may allow for advantageous interior designs. For instance, cargo can be loaded and/or passengers can board from the front or rear of the aircraft. A cargo or passenger area may be distributed across a relatively wide (when compared to tube-wing aircraft) fuselage, providing a large usable volume. In some embodiments, passengers seated within an interior of aircraft, real-time video at every seat can take place of window seats.

With continued reference to FIG. 6, BWB 604 of aircraft 600 may include a nose portion. A “nose portion,” for the purposes of this disclosure, refers to any portion of aircraft 600 forward of the aircraft's fuselage 612. Nose portion may comprise a cockpit (for manned aircraft), canopy, aerodynamic fairings, windshield, and/or any structural elements required to support mechanical loads. Nose portion may also include pilot seats, control interfaces, gages, displays, inceptor sticks, throttle controls, collective pitch controls, and/or communication equipment, to name a few. Nose portion may comprise a swing nose configuration. A swing nose may be characterized by an ability of the nose to move, manually or automatedly, into a differing orientation than its flight orientation to provide an opening for loading a payload into aircraft fuselage from the front of the aircraft. Nose portion may be configured to open in a plurality of orientations and directions.

With continued reference to FIG. 6, BWB 604 may include at least a structural component of aircraft 600. Structural components may provide physical stability during an entirety of an aircraft's 600 flight envelope, while on ground, and during normal operation Structural components may comprise struts, beams, formers, stringers, longerons, interstitials, ribs, structural skin, doublers, straps, spars, or panels, to name a few. Structural components may also comprise pillars. In some cases, for the purpose of aircraft cockpits comprising windows/windshields, pillars may include vertical or near vertical supports around a window configured to provide extra stability around weak points in a vehicle's structure, such as an opening where a window is installed. Where multiple pillars are disposed in an aircraft's 600 structure, they may be so named A, B, C, and so on named from nose to tail. Pillars, like any structural element, may be disposed a distance away from each other, along an exterior of aircraft 600 and BWB 604. Depending on manufacturing method of BWB 604, pillars may be integral to frame and skin, comprised entirely of internal framing, or alternatively, may be only integral to structural skin elements. Structural skin will be discussed in greater detail below.

With continued reference to FIG. 6, BWB 604 may include a plurality of materials, alone or in combination, in its construction. At least a BWB 604, in an illustrative embodiment may include a welded steel tube frame further configured to form a general shape of a nose corresponding to an arrangement of steel tubes. Steel may include any of a plurality of alloyed metals, including but not limited to, a varying amount of manganese, nickel, copper, molybdenum, silicon, and/or aluminum, to name a few. Welded steel tubes may be covered in any of a plurality of materials suitable for aircraft skin. Some of these may include carbon fiber, fiberglass panels, cloth-like materials, aluminum sheeting, or the like. BWB 604 may comprise aluminum tubing mechanically coupled in various and orientations. Mechanical fastening of aluminum members (whether pure aluminum or alloys) may comprise temporary or permanent mechanical fasteners appreciable by one of ordinary skill in the art including, but not limited to, screws, nuts and bolts, anchors, clips, welding, brazing, crimping, nails, blind rivets, pull-through rivets, pins, dowels, snap-fits, clamps, and the like. BWB 604 may additionally or alternatively use wood or another suitably strong yet light material for an internal structure.

With continued reference to FIG. 6, aircraft 600 may include monocoque or semi-monocoque construction. BWB 604 may include carbon fiber. Carbon fiber may include carbon fiber reinforced polymer, carbon fiber reinforced plastic, or carbon fiber reinforced thermoplastic (e.g., CFRP, CRP, CFRTP, carbon composite, or just carbon, depending on industry). “Carbon fiber,” as used in this disclosure, is a composite material including a polymer reinforced with carbon. In general, carbon fiber composites consist of two parts, a matrix and a reinforcement. In carbon fiber reinforced plastic, the carbon fiber constitutes the reinforcement, which provides strength. The matrix can include a polymer resin, such as epoxy, to bind reinforcements together. Such reinforcement achieves an increase in CFRP's strength and rigidity, measured by stress and elastic modulus, respectively. In embodiments, carbon fibers themselves can each comprise a diameter between 5-10 micrometers and include a high percentage (i.e. above 85%) of carbon atoms. A person of ordinary skill in the art will appreciate that the advantages of carbon fibers include high stiffness, high tensile strength, low weight, high chemical resistance, high temperature tolerance, and low thermal expansion. According to embodiments, carbon fibers may be combined with other materials to form a composite, when permeated with plastic resin and baked, carbon fiber reinforced polymer becomes extremely rigid. Rigidity may be considered analogous to stiffness which may be measured using Young's Modulus. Rigidity may be defined as a force necessary to bend and/or flex a material and/or structure to a given degree. For example, ceramics have high rigidity, which can be visualized by shattering before bending. In embodiments, carbon fibers may additionally, or alternatively, be composited with other materials like graphite to form reinforced carbon-carbon composites, which include high heat tolerances over 6000° C. A person of skill in the art will further appreciate that aerospace applications may require high-strength, low-weight, high heat resistance materials in a plurality of roles, such as without limitation fuselages, fairings, control surfaces, and structures, among others.

With continued reference to FIG. 6, BWB 604 may include at least a fuselage. A “fuselage,” for the purposes of this disclosure, refers to a main body of an aircraft 600, or in other words, an entirety of the aircraft 600 except for nose, wings, empennage, nacelles, and control surfaces. In some cases, fuselage may contain an aircraft's payload. At least a fuselage may comprise structural components that physically support a shape and structure of an aircraft 600. Structural components may take a plurality of forms, alone or in combination with other types. Structural components vary depending on construction type of aircraft 600 and specifically, fuselage. A fuselage 612 may include a truss structure. A truss structure may be used with a lightweight aircraft. A truss structure may include welded steel tube trusses. A “truss,” as used in this disclosure, is an assembly of beams that create a rigid structure, for example without limitation including combinations of triangles to create three-dimensional shapes. A truss structure may include wood construction in place of steel tubes, or a combination thereof. In some embodiments, structural components can comprise steel tubes and/or wood beams. An aircraft skin may be layered over a body shape constructed by trusses. Aircraft skin may comprise a plurality of materials such as plywood sheets, aluminum, fiberglass, and/or carbon fiber.

With continued reference to FIG. 6, in embodiments, at least a fuselage may comprise geodesic construction. Geodesic structural elements may include stringers wound about formers (which may be alternatively called station frames) in opposing spiral directions. A “stringer,” for the purposes of this disclosure is a general structural element that includes a long, thin, and rigid strip of metal or wood that is mechanically coupled to and spans the distance from, station frame to station frame to create an internal skeleton on which to mechanically couple aircraft skin. A former (or station frame) can include a rigid structural element that is disposed along a length of an interior of a fuselage orthogonal to a longitudinal (nose to tail) axis of aircraft 600. In some cases, a former forms a general shape of at least a fuselage. A former may include differing cross-sectional shapes at differing locations along a fuselage, as the former is a structural component that informs an overall shape of the fuselage. In embodiments, aircraft skin can be anchored to formers and strings such that an outer mold line of volume encapsulated by the formers and stringers comprises a same shape as aircraft 600 when installed. In other words, former(s) may form a fuselage's ribs, and stringers may form interstitials between the ribs. A spiral orientation of stringers about formers may provide uniform robustness at any point on an aircraft fuselage such that if a portion sustains damage, another portion may remain largely unaffected. Aircraft skin may be mechanically coupled to underlying stringers and formers and may interact with a fluid, such as air, to generate lift and perform maneuvers.

With continued reference to FIG. 6, according to some embodiments, a fuselage can comprise monocoque construction. Monocoque construction can include a primary structure that forms a shell (or skin in an aircraft's case) and supports physical loads. Monocoque fuselages are fuselages in which the aircraft skin or shell may also include a primary structure. In monocoque construction aircraft skin would support tensile and compressive loads within itself and true monocoque aircraft can be further characterized by an absence of internal structural elements. Aircraft skin in this construction method may be rigid and can sustain its shape with substantially no structural assistance form underlying skeleton-like elements. Monocoque fuselage may include aircraft skin made from plywood layered in varying grain directions, epoxy-impregnated fiberglass, carbon fiber, or any combination thereof.

With continued reference to FIG. 6, according to some embodiments, a fuselage may include a semi-monocoque construction. Semi-monocoque construction, as used in this disclosure, is used interchangeably with partially monocoque construction, discussed above. In semi-monocoque construction, a fuselage may derive some structural support from stressed aircraft skin and some structural support from underlying frame structure made of structural components. Formers or station frames can be seen running transverse to a long axis of fuselage with circular cutouts which may be used in real-world manufacturing for weight savings and for routing of electrical harnesses and other modern on-board systems. In a semi-monocoque construction, stringers may be thin, long strips of material that run parallel to a fuselage's long axis. Stringers can be mechanically coupled to formers permanently, such as with rivets. Aircraft skin can be mechanically coupled to stringers and formers permanently, such as by rivets as well. A person of ordinary skill in the art will appreciate that there are numerous methods for mechanical fastening of the aforementioned components like screws, nails, dowels, pins, anchors, adhesives like glue or epoxy, or bolts and nuts, to name a few. According to some embodiments, a subset of semi-monocoque construction may be unibody construction. Unibody, which is short for “unitized body” or alternatively “unitary construction”, vehicles are characterized by a construction in which body, floor plan, and chassis form a single structure, for example an automobile. In the aircraft world, a unibody may include internal structural elements, like formers and stringers, constructed in one piece, integral to an aircraft skin. In some cases, stringers and formers may account for a bulk of any aircraft structure (excluding monocoque construction). Stringers and formers can be arranged in a plurality of orientations depending on aircraft operation and materials. Stringers may be arranged to carry axial (tensile or compressive), shear, bending or torsion forces throughout their overall structure. Due to their coupling to aircraft skin, aerodynamic forces exerted on aircraft skin may be transferred to stringers. Location of said stringers greatly informs type of forces and loads applied to each and every stringer, all of which may be accounted for through design processes including, material selection, cross-sectional area, and mechanical coupling methods of each member. Similar methods may be performed for former assessment and design. In general, formers may be significantly larger in cross-sectional area and thickness, depending on location, than stringers. Both stringers and formers may comprise aluminum, aluminum alloys, graphite epoxy composite, steel alloys, titanium, or an undisclosed material alone or in combination.

With continued reference to FIG. 6, in some cases, a primary purpose for a substructure of a semi-monocoque structure is to stabilize a skin. Typically, aircraft structure is required to have a very light weight and as a result, in some cases, aircraft skin may be very thin. In some cases, unless supported, this thin skin structure may tend to buckle and/or cripple under compressive and/or shear loads. In some cases, underlying structure may be primarily configured to stabilize skins. For example, in an exemplary airliner, wing structure is an airfoil-shaped box with truncated nose and aft triangle; without stabilizing substructure, in some cases, this box would buckle upper skin of the wing and the upper skin would also collapse into the lower skin under bending loads. In some cases, deformations are prevented with ribs that support stringers which stabilize the skin. Fuselages are similar with bulkheads or frames, and stringers.

With continued reference to FIG. 6, in some embodiments, another common structural form is sandwich structure. As used in this disclosure, “sandwich structure” includes a skin structure having an inner and outer skin separated and stabilized by a core material. In some cases, sandwich structure may additionally include some number of ribs or frames. In some cases, sandwich structure may include metal, polymer, and/or composite. In some cases, core material may include honeycomb, foam plastic, and/or end-grain balsa wood. In some cases, sandwich structure can be popular on composite light airplanes, such as gliders and powered light planes. In some cases, sandwich structure may not use stringers, and sandwich structure may allow number of ribs or frames to be reduced, for instance in comparison with a semi-monocoque structure. In some cases, sandwich structure may be suitable for smaller, possibly unmanned, unpressurized blended wing body aircraft.

With continued reference to FIG. 6, stressed skin, when used in semi-monocoque construction, may bear partial, yet significant, load. In other words, an internal structure, whether it be a frame of welded tubes, formers and stringers, or some combination, is not sufficiently strong enough by design to bear all loads. The concept of stressed skin is applied in monocoque and semi-monocoque construction methods of at least a fuselage and/or BWB 604. In some cases, monocoque may be considered to include substantially only structural skin, and in that sense, aircraft skin undergoes stress by applied aerodynamic fluids imparted by fluid. Stress as used in continuum mechanics can be described in pound-force per square inch (lbf/in⁶) or Pascals (Pa). In semi-monocoque construction stressed skin bears part of aerodynamic loads and additionally imparts force on an underlying structure of stringers and formers.

With continued reference to FIG. 6, a fuselage may include an interior cavity. An interior cavity may include a volumetric space configurable to house passenger seats and/or cargo. An interior cavity may be configured to include receptacles for fuel tanks, batteries, fuel cells, or other energy sources as described herein. In some cases, a post may be supporting a floor (i.e., deck), or in other words a surface on which a passenger, operator, passenger, payload, or other object would rest on due to gravity when within an aircraft 600 is in its level flight orientation or sitting on ground. A post may act similarly to stringer in that it is configured to support axial loads in compression due to a load being applied parallel to its axis due to, for example, a heavy object being placed on a floor of aircraft 600. A beam may be disposed in or on any portion a fuselage that requires additional bracing, specifically when disposed transverse to another structural element, like a post, which would benefit from support in that direction, opposing applied force. A beam may be disposed in a plurality of locations and orientations within a fuselage as necessitated by operational and constructional requirements.

With continued reference to FIG. 6, aircraft 600 may include at least a flight component 608. A flight component 608 may be consistent with any description of a flight component described in this disclosure, such as without limitation propulsors, control surfaces, rotors, paddle wheels, engines, propellers, wings, winglets, or the like. For the purposes of this disclosure, at least a “flight component” is at least one element of an aircraft 600 configured to manipulate a fluid medium such as air to propel, control, or maneuver an aircraft. In nonlimiting examples, at least a flight component may include a rotor mechanically connected to a rotor shaft of an electric motor further mechanically affixed to at least a portion of aircraft 600. In some embodiments, at least a flight component 608 may include a propulsor, for example a rotor attached to an electric motor configured to produce shaft torque and in turn, create thrust. As used in this disclosure, an “electric motor” is an electrical machine that converts electric energy into mechanical work.

With continued reference to FIG. 6, for the purposes of this disclosure, “torque”, is a twisting force that tends to cause rotation. Torque may be considered an effort and a rotational analogue to linear force. A magnitude of torque of a rigid body may depend on three quantities: a force applied, a lever arm vector connecting a point about which the torque is being measured to a point of force application, and an angle between the force and the lever arm vector. A force applied perpendicularly to a lever multiplied by its distance from the lever's fulcrum (the length of the lever arm) is its torque. A force of three newtons applied two meters from the fulcrum, for example, exerts the same torque as a force of one newton applied six meters from the fulcrum. In some cases, direction of a torque can be determined by using a right-hand grip rule which states: if fingers of right hand are curled from a direction of lever arm to direction of force, then thumb points in a direction of the torque. One of ordinary skill in the art would appreciate that torque may be represented as a vector, consistent with this disclosure, and therefore may include a magnitude and a direction. “Torque” and “moment” are used interchangeably within this disclosure. Any torque command or signal within this disclosure may include at least the steady state torque to achieve the torque output to at least a propulsor.

With continued reference to FIG. 6, at least a flight component may be one or more devices configured to affect aircraft's 600 attitude. “Attitude”, for the purposes of this disclosure, is the relative orientation of a body, in this case aircraft 600, as compared to earth's surface or any other reference point and/or coordinate system. In some cases, attitude may be displayed to pilots, personnel, remote users, or one or more computing devices in an attitude indicator, such as without limitation a visual representation of a horizon and its relative orientation to aircraft 600. A plurality of attitude datums may indicate one or more measurements relative to an aircraft's pitch, roll, yaw, or throttle compared to a relative starting point. One or more sensors may measure or detect an aircraft's 600 attitude and establish one or more attitude datums. An “attitude datum”, for the purposes of this disclosure, refers to at least an element of data identifying an attitude of an aircraft 600.

With continued reference to FIG. 6, in some cases, aircraft 600 may include one or more of an angle of attack sensor and a yaw sensor. In some embodiments, one or more of an angle of attack sensor and a yaw sensor may include a vane (e.g., wind vane). In some cases, vane may include a protrusion on a pivot with an aft tail. The protrusion may be configured to rotate about pivot to maintain zero tail angle of attack. In some cases, pivot may turn an electronic device that reports one or more of angle of attack and/or yaw, depending on, for example, orientation of the pivot and tail. Alternatively or additionally, in some cases, one or more of angle of attack sensor and/or yaw sensor may include a plurality of pressure ports located in selected locations, with pressure sensors located at each pressure port. In some cases, differential pressure between pressure ports can be used to estimate angle of attack and/or yaw.

With continued reference to FIG. 6, in some cases, aircraft 600 may include at least a pilot control. As used in this disclosure, a “pilot control,” is an interface device that allows an operator, human or machine, to control a flight component of an aircraft. Pilot control may be communicatively connected to any other component presented in aircraft 600, the communicative connection may include redundant connections configured to safeguard against single-point failure. In some cases, a plurality of attitude datums may indicate a pilot's instruction to change heading and/or trim of an aircraft 600. Pilot input may indicate a pilot's instruction to change an aircraft's pitch, roll, yaw, throttle, and/or any combination thereof. Aircraft trajectory may be manipulated by one or more control surfaces and propulsors working alone or in tandem consistent with the entirety of this disclosure. “Pitch”, for the purposes of this disclosure refers to an aircraft's angle of attack, which is a difference between a plane including at least a portion of both wings of the aircraft running nose to tail and a horizontal flight trajectory. For example, an aircraft may pitch “up” when its nose is angled upward compared to horizontal flight, as in a climb maneuver. In another example, an aircraft may pitch “down”, when its nose is angled downward compared to horizontal flight, like in a dive maneuver. In some cases, angle of attack may not be used as an input, for instance pilot input, to any system disclosed herein; in such circumstances proxies may be used such as pilot controls, remote controls, or sensor levels, such as true airspeed sensors, pitot tubes, pneumatic/hydraulic sensors, and the like. “Roll” for the purposes of this disclosure, refers to an aircraft's position about its longitudinal axis, which is to say that when an aircraft rotates about its axis from its tail to its nose, and one side rolls upward, as in a banking maneuver. “Yaw”, for the purposes of this disclosure, refers to an aircraft's turn angle, when an aircraft rotates about an imaginary vertical axis intersecting center of earth and aircraft 600. “Throttle”, for the purposes of this disclosure, refers to an aircraft outputting an amount of thrust from a propulsor. In context of a pilot input, throttle may refer to a pilot's input to increase or decrease thrust produced by at least a propulsor. Flight components 608 may receive and/or transmit signals, for example an aircraft command signal. Aircraft command signal may include any signal described in this disclosure, such as without limitation electrical signal, optical signal, pneumatic signal, hydraulic signal, and/or mechanical signal. In some cases, an aircraft command may be a function of a signal from a pilot control. In some cases, an aircraft command may include or be determined as a function of a pilot command. For example, aircraft commands may be determined as a function of a mechanical movement of a throttle. Signals may include analog signals, digital signals, periodic or aperiodic signal, step signals, unit impulse signal, unit ramp signal, unit parabolic signal, signum function, exponential signal, rectangular signal, triangular signal, sinusoidal signal, sinc function, or pulse width modulated signal. Pilot control may include circuitry, computing devices, electronic components or a combination thereof that translates pilot input into a signal configured to be transmitted to another electronic component. In some cases, a plurality of attitude commands may be determined as a function of an input to a pilot control. A plurality of attitude commands may include a total attitude command datum, such as a combination of attitude adjustments represented by one or a certain number of combinatorial datums. A plurality of attitude commands may include individual attitude datums representing total or relative change in attitude measurements relative to pitch, roll, yaw, and throttle.

With continued reference to FIG. 6, in some embodiments, pilot control may include at least a sensor. As used in this disclosure, a “sensor” is a device that detects a phenomenon. In some cases, a sensor may detect a phenomenon and transmit a signal that is representative of the phenomenon. At least a sensor may include, torque sensor, gyroscope, accelerometer, magnetometer, inertial measurement unit (IMU), pressure sensor, force sensor, proximity sensor, displacement sensor, vibration sensor, among others. At least a sensor may include a sensor suite which may include a plurality of sensors that may detect similar or unique phenomena. For example, in a non-limiting embodiment, sensor suite may include a plurality of accelerometers, a mixture of accelerometers and gyroscopes, or a mixture of an accelerometer, gyroscope, and torque sensor. For the purposes of the disclosure, a “torque datum” is one or more elements of data representing one or more parameters detailing power output by one or more propulsors, flight components, or other elements of an electric aircraft. A torque datum may indicate the torque output of at least a flight component 608. At least a flight component 608 may include any propulsor as described herein. In embodiment, at least a flight component 608 may include an electric motor, a propeller, a jet engine, a paddle wheel, a rotor, turbine, or any other mechanism configured to manipulate a fluid medium to propel an aircraft as described herein. an embodiment of at least a sensor may include or be included in, a sensor suite. The herein disclosed system and method may comprise a plurality of sensors in the form of individual sensors or a sensor suite working in tandem or individually. A sensor suite may include a plurality of independent sensors, as described herein, where any number of the described sensors may be used to detect any number of physical or electrical quantities associated with an aircraft power system or an electrical energy storage system. Independent sensors may include separate sensors measuring physical or electrical quantities that may be powered by and/or in communication with circuits independently, where each may signal sensor output to a control circuit such as a user graphical interface. In a non-limiting example, there may be four independent sensors housed in and/or on battery pack measuring temperature, electrical characteristic such as voltage, amperage, resistance, or impedance, or any other parameters and/or quantities as described in this disclosure. In an embodiment, use of a plurality of independent sensors may result in redundancy configured to employ more than one sensor that measures the same phenomenon, those sensors being of the same type, a combination of, or another type of sensor not disclosed, so that in the event one sensor fails, the ability of a battery management system and/or user to detect phenomenon is maintained and in a non-limiting example, a user alter aircraft usage pursuant to sensor readings.

With continued reference to FIG. 6, at least a sensor may include a moisture sensor. “Moisture”, as used in this disclosure, is the presence of water, this may include vaporized water in air, condensation on the surfaces of objects, or concentrations of liquid water. Moisture may include humidity. “Humidity”, as used in this disclosure, is the property of a gaseous medium (almost always air) to hold water in the form of vapor. An amount of water vapor contained within a parcel of air can vary significantly. Water vapor is generally invisible to the human eye and may be damaging to electrical components. There are three primary measurements of humidity, absolute, relative, specific humidity. “Absolute humidity,” for the purposes of this disclosure, describes the water content of air and is expressed in either grams per cubic meters or grams per kilogram. “Relative humidity”, for the purposes of this disclosure, is expressed as a percentage, indicating a present stat of absolute humidity relative to a maximum humidity given the same temperature. “Specific humidity”, for the purposes of this disclosure, is the ratio of water vapor mass to total moist air parcel mass, where parcel is a given portion of a gaseous medium. A moisture sensor may be psychrometer. A moisture sensor may be a hygrometer. A moisture sensor may be configured to act as or include a humidistat. A “humidistat”, for the purposes of this disclosure, is a humidity-triggered switch, often used to control another electronic device. A moisture sensor may use capacitance to measure relative humidity and include in itself, or as an external component, include a device to convert relative humidity measurements to absolute humidity measurements. “Capacitance”, for the purposes of this disclosure, is the ability of a system to store an electric charge, in this case the system is a parcel of air which may be near, adjacent to, or above a battery cell.

With continued reference to FIG. 6, at least a sensor may include electrical sensors. An electrical sensor may be configured to measure voltage across a component, electrical current through a component, and resistance of a component. Electrical sensors may include separate sensors to measure each of the previously disclosed electrical characteristics such as voltmeter, ammeter, and ohmmeter, respectively. One or more sensors may be communicatively coupled to at least a pilot control, the manipulation of which, may constitute at least an aircraft command. Signals may include electrical, electromagnetic, visual, audio, radio waves, or another undisclosed signal type alone or in combination. At least a sensor communicatively connected to at least a pilot control may include a sensor disposed on, near, around or within at least pilot control. At least a sensor may include a motion sensor. “Motion sensor”, for the purposes of this disclosure refers to a device or component configured to detect physical movement of an object or grouping of objects. One of ordinary skill in the art would appreciate, after reviewing the entirety of this disclosure, that motion may include a plurality of types including but not limited to: spinning, rotating, oscillating, gyrating, jumping, sliding, reciprocating, or the like. At least a sensor may include, torque sensor, gyroscope, accelerometer, torque sensor, magnetometer, inertial measurement unit (IMU), pressure sensor, force sensor, proximity sensor, displacement sensor, vibration sensor, among others. At least a sensor may include a sensor suite which may include a plurality of sensors that may detect similar or unique phenomena. For example, in a non-limiting embodiment, sensor suite may include a plurality of accelerometers, a mixture of accelerometers and gyroscopes, or a mixture of an accelerometer, gyroscope, and torque sensor. The herein disclosed system and method may comprise a plurality of sensors in the form of individual sensors or a sensor suite working in tandem or individually. A sensor suite may include a plurality of independent sensors, as described herein, where any number of the described sensors may be used to detect any number of physical or electrical quantities associated with an aircraft power system or an electrical energy storage system. Independent sensors may include separate sensors measuring physical or electrical quantities that may be powered by and/or in communication with circuits independently, where each may signal sensor output to a control circuit such as a user graphical interface. In an embodiment, use of a plurality of independent sensors may result in redundancy configured to employ more than one sensor that measures the same phenomenon, those sensors being of the same type, a combination of, or another type of sensor not disclosed, so that in the event one sensor fails, the ability to detect phenomenon is maintained and in a non-limiting example, a user alter aircraft usage pursuant to sensor readings.

With continued reference to FIG. 6, at least a flight component 608 may include wings, empennages, nacelles, control surfaces, fuselages, and landing gear, among others, to name a few. In embodiments, an empennage may be disposed at the aftmost point of an aircraft body 604. Empennage may comprise a tail of aircraft 600, further comprising rudders, vertical stabilizers, horizontal stabilizers, stabilators, elevators, trim tabs, among others. At least a portion of empennage may be manipulated directly or indirectly by pilot commands to impart control forces on a fluid in which the aircraft 600 is flying. Manipulation of these empennage control surfaces may, in part, change an aircraft's heading in pitch, roll, and yaw. Wings comprise may include structures which include airfoils configured to create a pressure differential resulting in lift. Wings are generally disposed on a left and right side of aircraft 600 symmetrically, at a point between nose and empennage. Wings may comprise a plurality of geometries in planform view, swept swing, tapered, variable wing, triangular, oblong, elliptical, square, among others. Wings may be blended into the body of the aircraft such as in a BWB 604 aircraft 600 where no strong delineation of body and wing exists. A wing's cross section geometry may comprise an airfoil. An “airfoil” as used in this disclosure, is a shape specifically designed such that a fluid flowing on opposing sides of it exert differing levels of pressure against the airfoil. In embodiments, a bottom surface of an aircraft can be configured to generate a greater pressure than does a top surface, resulting in lift. A wing may comprise differing and/or similar cross-sectional geometries over its cord length, e.g. length from wing tip to where wing meets the aircraft's body. One or more wings may be symmetrical about an aircraft's longitudinal plane, which comprises a longitudinal or roll axis reaching down a center of the aircraft through the nose and empennage, and the aircraft's yaw axis. In some cases, wings may comprise controls surfaces configured to be commanded by a pilot and/or autopilot to change a wing's geometry and therefore its interaction with a fluid medium. Flight component 608 may include control surfaces. Control surfaces may include without limitation flaps, ailerons, tabs, spoilers, and slats, among others. In some cases, control surfaces may be disposed on wings in a plurality of locations and arrangements. In some cases, control surfaces may be disposed at leading and/or trailing edges of wings, and may be configured to deflect up, down, forward, aft, or any combination thereof.

In some cases, flight component 608 may include a winglet. For the purposes of this disclosure, a “winglet” is a flight component configured to manipulate a fluid medium and is mechanically attached to a wing or aircraft and may alternatively called a “wingtip device.” Wingtip devices may be used to improve efficiency of fixed-wing aircraft by reducing drag. Although there are several types of wingtip devices which function in different manners, their intended effect may be to reduce an aircraft's drag by partial recovery of tip vortex energy. Wingtip devices can also improve aircraft handling characteristics and enhance safety for aircraft 600. Such devices increase an effective aspect ratio of a wing without greatly increasing wingspan. Extending wingspan may lower lift-induced drag, but would increase parasitic drag and would require boosting the strength and weight of the wing. As a result according to some aeronautic design equations, a maximum wingspan made be determined above which no net benefit exits from further increased span. There may also be operational considerations that limit the allowable wingspan (e.g., available width at airport gates).

Wingtip devices, in some cases, may increase lift generated at wingtip (by smoothing airflow across an upper wing near the wingtip) and reduce lift-induced drag caused by wingtip vortices, thereby improving a lift-to-drag ratio. This increases fuel efficiency in powered aircraft and increases cross-country speed in gliders, in both cases increasing range. U.S. Air Force studies indicate that a given improvement in fuel efficiency correlates directly and causally with increase in an aircraft's lift-to-drag ratio. The term “winglet” has previously been used to describe an additional lifting surface on an aircraft, like a short section between wheels on fixed undercarriage. An upward angle (i.e., cant) of a winglet, its inward or outward angle (i.e., toe), as well as its size and shape are selectable design parameters which may be chosen for correct performance in a given application. A wingtip vortex, which rotates around from below a wing, strikes a cambered surface of a winglet, generating a force that angles inward and slightly forward. A winglet's relation to a wingtip vortex may be considered analogous to sailboat sails when sailing to windward (i.e., close-hauled). Similar to the close-hauled sailboat's sails, winglets may convert some of what would otherwise-be wasted energy in a wingtip vortex to an apparent thrust. This small contribution can be worthwhile over the aircraft's lifetime. Another potential benefit of winglets is that they may reduce an intensity of wake vortices. Wake vortices may trail behind an aircraft 600 and pose a hazard to other aircraft. Minimum spacing requirements between aircraft at airports are largely dictated by hazards, like those from wake vortices. Aircraft are classified by weight (e.g., “Light,” “Heavy,” and the like) often base upon vortex strength, which grows with an aircraft's lift coefficient. Thus, associated turbulence is greatest at low speed and high weight, which may be produced at high angle of attack near airports. Winglets and wingtip fences may also increase efficiency by reducing vortex interference with laminar airflow near wingtips, by moving a confluence of low-pressure air (over wing) and high-pressure air (under wing) away from a surface of the wing. Wingtip vortices create turbulence, which may originate at a leading edge of a wingtip and propagate backwards and inboard. This turbulence may delaminate airflow over a small triangular section of an outboard wing, thereby frustrating lift in that area. A fence/winglet drives an area where a vortex forms upward away from a wing surface, as the resulting vortex is repositioned to a top tip of the winglet.

With continued reference to FIG. 6, aircraft 600 may include an energy source. Energy source may include any device providing energy to at least a flight component 608, for example at least a propulsors. Energy source may include, without limitation, a generator, a photovoltaic device, a fuel cell such as a hydrogen fuel cell, direct methanol fuel cell, and/or solid oxide fuel cell, or an electric energy storage device; electric energy storage device may include without limitation a battery, a capacitor, and/or inductor. The energy source and/or energy storage device may include at least a battery, battery cell, and/or a plurality of battery cells connected in series, in parallel, or in a combination of series and parallel connections such as series connections into modules that are connected in parallel with other like modules. Battery and/or battery cell may include, without limitation, Li ion batteries which may include NCA, NMC, Lithium iron phosphate (LiFePO4) and Lithium Manganese Oxide (LMO) batteries, which may be mixed with another cathode chemistry to provide more specific power if the application requires Li metal batteries, which have a lithium metal anode that provides high power on demand, Li ion batteries that have a silicon or titanite anode. In embodiments, the energy source may be used to provide electrical power to an electric or hybrid propulsor during moments requiring high rates of power output, including without limitation takeoff, landing, thermal de-icing and situations requiring greater power output for reasons of stability, such as high turbulence situations. In some cases, battery may include, without limitation a battery using nickel based chemistries such as nickel cadmium or nickel metal hydride, a battery using lithium ion battery chemistries such as a nickel cobalt aluminum (NCA), nickel manganese cobalt (NMC), lithium iron phosphate (LiFePO4), lithium cobalt oxide (LCO), and/or lithium manganese oxide (LMO), a battery using lithium polymer technology, lead-based batteries such as without limitation lead acid batteries, metal-air batteries, or any other suitable battery. A person of ordinary skill in the art, upon reviewing the entirety of this disclosure, will be aware of various devices of components that may be used as an energy source.

With continued reference to FIG. 6, in further nonlimiting embodiments, an energy source may include a fuel store. As used in this disclosure, a “fuel store” is an aircraft component configured to store a fuel. In some cases, a fuel store may include a fuel tank. Fuel may include a liquid fuel, a gaseous fluid, a solid fuel, and fluid fuel, a plasma fuel, and the like. As used in this disclosure, a “fuel” may include any substance that stores energy. Exemplary non-limiting fuels include hydrocarbon fuels, petroleum-based fuels, synthetic fuels, chemical fuels, Jet fuels (e.g., Jet-A fuel, Jet-B fuel, and the like), kerosene-based fuel, gasoline-based fuel, an electrochemical-based fuel (e.g., lithium-ion battery), a hydrogen-based fuel, natural gas-based fuel, and the like. As described in greater detail below fuel store may be located substantially within blended wing body 604 of aircraft 600, for example without limitation within a wing portion of blended wing body 608. Aviation fuels may include petroleum-based fuels, or petroleum and synthetic fuel blends, used to power aircraft 600. In some cases, aviation fuels may have more stringent requirements than fuels used for ground use, such as heating and road transport. Aviation fuels may contain additives to enhance or maintain properties important to fuel performance or handling. Fuel may be kerosene-based (JP-8 and Jet A-1), for example for gas turbine-powered aircraft. Piston-engine aircraft may use gasoline-based fuels and/or kerosene-based fuels (for example for Diesel engines). In some cases, specific energy may be considered an important criterion in selecting fuel for an aircraft 600. Liquid fuel may include Jet-A. Presently Jet-A powers modern commercial airliners and is a mix of extremely refined kerosene and burns at temperatures at or above 49° C. (160° F.). Kerosene-based fuel has a much higher flash point than gasoline-based fuel, meaning that it requires significantly higher temperature to ignite.

With continued reference to FIG. 6, modular aircraft 600 may include an energy source which may include a fuel cell. As used in this disclosure, a “fuel cell” is an electrochemical device that combines a fuel and an oxidizing agent to create electricity. In some cases, fuel cells are different from most batteries in requiring a continuous source of fuel and oxygen (usually from air) to sustain the chemical reaction, whereas in a battery the chemical energy comes from metals and their ions or oxides that are commonly already present in the battery, except in flow batteries. Fuel cells can produce electricity continuously for as long as fuel and oxygen are supplied.

With continued reference to FIG. 6, in some embodiments, fuel cells may consist of different types. Commonly a fuel cell consists of an anode, a cathode, and an electrolyte that allows ions, often positively charged hydrogen ions (protons), to move between two sides of the fuel cell. At anode, a catalyst causes fuel to undergo oxidation reactions that generate ions (often positively charged hydrogen ions) and electrons. Ions move from anode to cathode through electrolyte. Concurrently, electrons may flow from anode to cathode through an external circuit, producing direct current electricity. At cathode, another catalyst causes ions, electrons, and oxygen to react, forming water and possibly other products. Fuel cells may be classified by type of electrolyte used and by difference in startup time ranging from 6 second for proton-exchange membrane fuel cells (PEM fuel cells, or PEMFC) to 10 minutes for solid oxide fuel cells (SOFC). In some cases, energy source may include a related technology, such as flow batteries. Within a flow battery fuel can be regenerated by recharging. Individual fuel cells produce relatively small electrical potentials, about 0.7 volts. Therefore, in some cases, fuel cells may be “stacked”, or placed in series, to create sufficient voltage to meet an application's requirements. In addition to electricity, fuel cells may produce water, heat and, depending on the fuel source, very small amounts of nitrogen dioxide and other emissions. Energy efficiency of a fuel cell is generally between 40 and 90%.

Fuel cell may include an electrolyte. In some cases, electrolyte may define a type of fuel cell. Electrolyte may include any number of substances like potassium hydroxide, salt carbonates, and phosphoric acid. Commonly a fuel cell is fueled by hydrogen. Fuel cell may feature an anode catalyst, like fine platinum powder, which breaks down fuel into electrons and ions. Fuel cell may feature a cathode catalyst, often nickel, which converts ions into waste chemicals, with water being the most common type of waste. A fuel cell may include gas diffusion layers that are designed to resist oxidization.

With continued reference to FIG. 6, aircraft 600 may include an energy source which may include a cell such as a battery cell, or a plurality of battery cells making a battery module. An energy source may be a plurality of energy sources. The module may include batteries connected in parallel or in series or a plurality of modules connected either in series or in parallel designed to deliver both the power and energy requirements of the application. Connecting batteries in series may increase the voltage of an energy source which may provide more power on demand. High voltage batteries may require cell matching when high peak load is needed. As more cells are connected in strings, there may exist the possibility of one cell failing which may increase resistance in the module and reduce the overall power output as the voltage of the module may decrease as a result of that failing cell. Connecting batteries in parallel may increase total current capacity by decreasing total resistance, and it also may increase overall amp-hour capacity. The overall energy and power outputs of an energy source may be based on the individual battery cell performance or an extrapolation based on the measurement of at least an electrical parameter. In an embodiment where an energy source includes a plurality of battery cells, the overall power output capacity may be dependent on the electrical parameters of each individual cell. If one cell experiences high self-discharge during demand, power drawn from an energy source may be decreased to avoid damage to the weakest cell. An energy source may further include, without limitation, wiring, conduit, housing, cooling system and battery management system. Persons skilled in the art will be aware, after reviewing the entirety of this disclosure, of many different components of an energy source.

With continued reference to FIG. 6, aircraft 600 may include multiple flight component 608 sub-systems, each of which may have a separate energy source. For instance, and without limitation, one or more flight components 608 may have a dedicated energy source. Alternatively, or additionally, a plurality of energy sources may each provide power to two or more flight components 608, such as, without limitation, a “fore” energy source providing power to flight components located toward a front of an aircraft 600, while an “aft” energy source provides power to flight components located toward a rear of the aircraft 600. As a further non-limiting example, a flight component of group of flight components may be powered by a plurality of energy sources. For example, and without limitation, two or more energy sources may power one or more flight components; two energy sources may include, without limitation, at least a first energy source having high specific energy density and at least a second energy source having high specific power density, which may be selectively deployed as required for higher-power and lower-power needs. Alternatively, or additionally, a plurality of energy sources may be placed in parallel to provide power to the same single propulsor or plurality of propulsors 608. Alternatively, or additionally, two or more separate propulsion subsystems may be joined using intertie switches (not shown) causing the two or more separate propulsion subsystems to be treatable as a single propulsion subsystem or system, for which potential under load of combined energy sources may be used as the electric potential. Persons skilled in the art, upon reviewing the entirety of this disclosure, will be aware of various combinations of energy sources that may each provide power to single or multiple propulsors in various configurations.

With continued reference to FIG. 6, aircraft 600 may include a flight component 608 that includes at least a nacelle 608. For the purposes of this disclosure, a “nacelle” is a streamlined body housing, which is sized according to that which is houses, such as without limitation an engine, a fuel store, or a flight component. When attached by a pylon entirely outside an airframe 604 a nacelle may sometimes be referred to as a pod, in which case an engine within the nacelle may be referred to as a podded engine. In some cases an aircraft cockpit may also be housed in a nacelle, rather than in a fuselage. At least a nacelle may substantially encapsulate a propulsor, which may include a motor or an engine. At least a nacelle may be mechanically connected to at least a portion of aircraft 600 partially or wholly enveloped by an outer mold line of the aircraft 600. At least a nacelle may be designed to be streamlined. At least a nacelle may be asymmetrical about a plane comprising the longitudinal axis of the engine and the yaw axis of modular aircraft 600.

With continued reference to FIG. 6, a flight component may include a propulsor. A “propulsor,” as used herein, is a component or device used to propel a craft by exerting force on a fluid medium, which may include a gaseous medium such as air or a liquid medium such as water. For the purposes of this disclosure, “substantially encapsulate” is the state of a first body (e.g., housing) surrounding all or most of a second body. A motor may include without limitation, any electric motor, where an electric motor is a device that converts electrical energy into mechanical work for instance by causing a shaft to rotate. A motor may be driven by direct current (DC) electric power; for instance, a motor may include a brushed DC motor or the like. A motor may be driven by electric power having varying or reversing voltage levels, such as alternating current (AC) power as produced by an alternating current generator and/or inverter, or otherwise varying power, such as produced by a switching power source. A motor may include, without limitation, a brushless DC electric motor, a permanent magnet synchronous motor, a switched reluctance motor, and/or an induction motor; persons skilled in the art, upon reviewing the entirety of this disclosure, will be aware of various alternative or additional forms and/or configurations that a motor may take or exemplify as consistent with this disclosure. In addition to inverter and/or switching power source, a circuit driving motor may include electronic speed controllers or other components for regulating motor speed, rotation direction, torque, and/or dynamic braking. Motor may include or be connected to one or more sensors detecting one or more conditions of motor; one or more conditions may include, without limitation, voltage levels, electromotive force, current levels, temperature, current speed of rotation, position sensors, and the like. For instance, and without limitation, one or more sensors may be used to detect back-EMF, or to detect parameters used to determine back-EMF, as described in further detail below. One or more sensors may include a plurality of current sensors, voltage sensors, and speed or position feedback sensors. One or more sensors may communicate a current status of motor to a flight controller and/or a computing device; computing device may include any computing device as described in this disclosure, including without limitation, a flight controller.

With continued reference to FIG. 6, a motor may be connected to a thrust element. Thrust element may include any device or component that converts mechanical work, for example of a motor or engine, into thrust in a fluid medium. Thrust element may include, without limitation, a device using moving or rotating foils, including without limitation one or more rotors, an airscrew or propeller, a set of airscrews or propellers such as contra-rotating propellers or co-rotating propellers, a moving or flapping wing, or the like. Thrust element may include without limitation a marine propeller or screw, an impeller, a turbine, a pump-jet, a paddle or paddle-based device, or the like. Thrust element may include a rotor. Persons skilled in the art, upon reviewing the entirety of this disclosure, will be aware of various devices that may be used as thrust element. A thrust element may include any device or component that converts mechanical energy (i.e., work) of a motor, for instance in form of rotational motion of a shaft, into thrust within a fluid medium. As another non-limiting example, a thrust element may include an eight-bladed pusher propeller, such as an eight-bladed propeller mounted behind the engine to ensure the drive shaft is in compression.

With continued reference to FIG. 6, in nonlimiting embodiments, at least a flight component 608 may include an airbreathing engine such as a jet engine, turbojet engine, turboshaft engine, ramjet engine, scramjet engine, hybrid propulsion system, turbofan engine, or the like. At least a flight component 608 may be fueled by any fuel described in this disclosure, for instance without limitation Jet-A, Jet-B, diesel fuel, gasoline, or the like. In nonlimiting embodiments, a jet engine is a type of reaction engine discharging a fast-moving jet that generates thrust by jet propulsion. While this broad definition can include rocket, water jet, and hybrid propulsion, the term jet engine, in some cases, refers to an internal combustion airbreathing jet engine such as a turbojet, turbofan, ramjet, or pulse jet. In general, jet engines are internal combustion engines. As used in this disclosure, a “combustion engine” is a mechanical device that is configured to convert mechanical work from heat produced by combustion of a fuel. In some cases, a combustion engine may operate according to an approximation of a thermodynamic cycle, such as without limitation a Carnot cycle, a Cheng cycle, a Combined cycle, a Brayton cycle, an Otto cycle, an Allam power cycle, a Kalina cycle, a Rankine cycle, and/or the like. In some cases, a combustion engine may include an internal combustion engine. An internal combustion engine may include heat engine in which combustion of fuel occurs with an oxidizer (usually air) in a combustion chamber that comprises a part of a working fluid flow circuit. Exemplary internal combustion engines may without limitation a reciprocating engine (e.g., 4-stroke engine), a combustion turbine engine (e.g., jet engines, gas turbines, Brayton cycle engines, and the like), a rotary engine (e.g., Wankel engines), and the like. In nonlimiting embodiments, airbreathing jet engines feature a rotating air compressor powered by a turbine, with leftover power providing thrust through a propelling nozzle—this process may be known as a Brayton thermodynamic cycle. Jet aircraft may use such engines for long-distance travel. Early jet aircraft used turbojet engines that were relatively inefficient for subsonic flight. Most modern subsonic jet aircraft use more complex high-bypass turbofan engines. In some cases, they give higher speed and greater fuel efficiency than piston and propeller aeroengines over long distances. A few air-breathing engines made for highspeed applications (ramjets and scramjets) may use a ram effect of aircraft's speed instead of a mechanical compressor. An airbreathing jet engine (or ducted jet engine) may emit a jet of hot exhaust gases formed from air that is forced into the engine by several stages of centrifugal, axial or ram compression, which is then heated and expanded through a nozzle. In some cases, a majority of mass flow through an airbreathing jet engine may be provided by air taken from outside of the engine and heated internally, using energy stored in the form of fuel. In some cases, a jet engine may include are turbofans. Alternatively and/or additionally, jet engine may include a turbojets. In some cases, a turbofan may use a gas turbine engine core with high overall pressure ratio (e.g., 40:1) and high turbine entry temperature (e.g., about 1800 K) and provide thrust with a turbine-powered fan stage. In some cases, thrust may also be at least partially provided by way of pure exhaust thrust (as in a turbojet engine). In some cases, a turbofan may have a high efficiency, relative to a turbojet. In some cases, a jet engine may use simple ram effect (e.g., ramjet) or pulse combustion (e.g., pulsejet) to give compression. Persons skilled in the art, upon reviewing the entirety of this disclosure, will be aware of various devices that may be used as a thrust element.

With continued reference to FIG. 6, an aircraft 600 may include a flight controller. As used in this disclosure, a “flight controller” is a device that generates signals for controlling at least a flight component 608 of an aircraft 600. In some cases, a flight controller includes electronic circuitry, such as without limitation a digital signal processor (DSP), an application-specific integrated circuit (ASIC), and/or a computing device. Flight controller may use sensor feedback to calculate performance parameters of motor, including without limitation a torque versus speed operation envelope. Persons skilled in the art, upon reviewing the entirety of this disclosure, will be aware of various devices and/or components that may be used as or included in a motor or a circuit operating a motor, as used and described in this disclosure.

With continued reference to FIG. 6, computing device may include any computing device as described in this disclosure, including without limitation a microcontroller, microprocessor, digital signal processor (DSP) and/or system on a chip (SoC) as described in this disclosure. Computing device may include, be included in, and/or communicate with a mobile device such as a mobile telephone or smartphone. Computing device may include a single computing device operating independently, or may include two or more computing device operating in concert, in parallel, sequentially or the like; two or more computing devices may be included together in a single computing device or in two or more computing devices. Computing device may interface or communicate with one or more additional devices as described below in further detail via a network interface device. Network interface device may be utilized for connecting computing device to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software etc.) may be communicated to and/or from a computer and/or a computing device. Computing device may include but is not limited to, for example, a computing device or cluster of computing devices in a first location and a second computing device or cluster of computing devices in a second location. Computing device may include one or more computing devices dedicated to data storage, security, distribution of traffic for load balancing, and the like. Computing device may distribute one or more computing tasks as described below across a plurality of computing devices of computing device, which may operate in parallel, in series, redundantly, or in any other manner used for distribution of tasks or memory between computing devices. Computing device may be implemented using a “shared nothing” architecture in which data is cached at the worker, in an embodiment, this may enable scalability of system 600 and/or computing device.

With continued reference to FIG. 6, computing device may be designed and/or configured to perform any method, method step, or sequence of method steps in any embodiment described in this disclosure, in any order and with any degree of repetition. For instance, computing device may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Computing device may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

Referring now to FIG. 7, an exemplary aircraft 700 is represented with forward foldable wings. Exemplary aircraft 700 may include a controller 704, a blended wing body 708, at least a wing 712a-b, a main body 116, at least a hinge 720a-b, and at least an outboard flight component 724a-b consistent with description throughout this disclosure, including above with reference to FIG. 1. Additionally, aircraft 700 may include an actuation system (i.e., actuator) 728a-b. As used in this disclosure, an “actuation system” or “actuator” is a system that is configured to provide power (i.e., effort [force, torque, pressure, etc.] and flow [velocity, rotation velocity, volumetric flow, etc.]), work, or energy to generate a movement. In some cases, an actuation system 728a-b may be mechanically communicative with a hinge and provide power, work, or energy to move the hinge. In some cases, an actuating system may be configured to fold at least a wing 712a-b.

With continued reference to FIG. 7, an actuator 728a-b may include a component of a machine that is responsible for moving and/or controlling a mechanism or system. An actuator 728a-b may, in some cases, require a control signal and/or a source of energy or power. In some cases, a control signal may be relatively low energy. Exemplary control signal forms include electric potential or current, pneumatic pressure or flow, or hydraulic fluid pressure or flow, mechanical force/torque or velocity, or even human power. In some cases, an actuator may have an energy or power source other than control signal. This may include a main energy source, which may include for example electric power, hydraulic power, pneumatic power, mechanical power, and the like. In some cases, upon receiving a control signal, an actuator 728a-b responds by converting source power into mechanical motion. In some cases, an actuator 728a-b may be understood as a form of automation or automatic control.

With continued reference to FIG. 7, in some embodiments, actuator 728a-b may include a hydraulic actuator. A hydraulic actuator may consist of a cylinder or fluid motor that uses hydraulic power to facilitate mechanical operation. Output of hydraulic actuator 728a-b may include mechanical motion, such as without limitation linear, rotatory, or oscillatory motion. In some cases, hydraulic actuator may employ a liquid hydraulic fluid. As liquids, in some cases. are incompressible, a hydraulic actuator can exert large forces. Additionally, as force is equal to pressure multiplied by area, hydraulic actuators may act as force transformers with changes in area (e.g., cross sectional area of cylinder and/or piston). An exemplary hydraulic cylinder may consist of a hollow cylindrical tube within which a piston can slide. In some cases, a hydraulic cylinder may be considered single acting. Single acting may be used when fluid pressure is applied substantially to just one side of a piston. Consequently, a single acting piston can move in only one direction. In some cases, a spring may be used to give a single acting piston a return stroke. In some cases, a hydraulic cylinder may be double acting. Double acting may be used when pressure is applied substantially on each side of a piston; any difference in resultant force between the two sides of the piston causes the piston to move.

With continued reference to FIG. 7, in some embodiments, actuator 728a-b may include a pneumatic actuator 728a-b. In some cases, a pneumatic actuator may enable considerable forces to be produced from relatively small changes in gas pressure. In some cases, a pneumatic actuator may respond more quickly than other types of actuators, for example hydraulic actuators. A pneumatic actuator may use compressible flued (e.g., air). In some cases, a pneumatic actuator may operate on compressed air. Operation of hydraulic and/or pneumatic actuators may include control of one or more valves, circuits, fluid pumps, and/or fluid manifolds.

With continued reference to FIG. 7, in some cases, actuator 728a-b may include an electric actuator. Electric actuator 728a-b may include any of electromechanical actuators, linear motors, and the like. In some cases, actuator 728a-b may include an electromechanical actuator. An electromechanical actuator may convert a rotational force of an electric rotary motor or other electromechanical device such as a solenoid into a linear movement to generate a linear movement through a mechanism. Exemplary mechanisms, include rotational to translational motion transformers, such as without limitation a belt, a screw, a crank, a cam, a linkage, a scotch yoke, and the like. In some cases, control of an electromechanical actuator may include control of electric motor, for instance a control signal may control one or more electric motor parameters to control electromechanical actuator. Exemplary non-limitation electric motor parameters include rotational position, input torque, velocity, current, and potential. electric actuator 728a-b may include a linear motor. Linear motors 728a-b may differ from electromechanical actuators, as power from linear motors is output directly as translational motion, rather than output as rotational motion and converted to translational motion. In some cases, a linear motor may cause lower friction losses than other devices. Linear motors may be further specified into at least 3 different categories, including flat linear motor, U-channel linear motors and tubular linear motors. Linear motors 728a-b may controlled be directly controlled by a control signal for controlling one or more linear motor parameters. Exemplary linear motor parameters include without limitation position, force, velocity, potential, and current.

With continued reference to FIG. 7, in some embodiments, an actuator 728a-b may include a mechanical actuator 728a-b. In some cases, a mechanical actuator 728a-b may function to execute movement by converting one kind of motion, such as rotary motion, into another kind, such as linear motion. An exemplary mechanical actuator includes a rack and pinion. In some cases, a mechanical power source, such as a power take off may serve as power source for a mechanical actuator. Mechanical actuators may employ any number of mechanism, including for example without limitation gears, rails, pulleys, cables, linkages, and the like.

With continued reference to FIG. 7, a controller 704 may be configured to control actuation system 728a-b. For example, in some case, controller 704 may be in communication with actuation system 728a-b. Controller 704 may be in communication with actuation system 728a-b by way of one or more networks 732, such as a controller area network (CAN) 732. Controller 704 may send at least a control signal to actuation system 728a-b in order to control the actuation system. “Control signal,” as used in this disclosure, is a signal that represents information capable of or intended to control a device. Control signal may communicate an actuator 728a-b to fold and/or unfold wings 1174a-b. As used in this disclosure, a “signal” is any intelligible representation of data, for example from one device to another. A signal may include an optical signal, a hydraulic signal, a pneumatic signal, a mechanical, signal, an electric signal, a digital signal, an analog signal and the like. In some cases, a signal may be used to communicate with a computing device, for example by way of one or more ports. In some cases, a signal may be transmitted and/or received by a computing device, such as controller 704, for example by way of an input/output port. An analog signal may be digitized, for example by way of an analog to digital converter. In some cases, an analog signal may be processed, for example by way of any analog signal processing steps described in this disclosure, prior to digitization. In some cases, a digital signal may be used to communicate between two or more devices, including without limitation computing devices. In some cases, a digital signal may be communicated by way of one or more communication protocols, including without limitation internet protocol (IP), controller area network (CAN) protocols, serial communication protocols (e.g., universal asynchronous receiver-transmitter [UART]), parallel communication protocols (e.g., IEEE 178 [printer port]), and the like.

With continued reference to FIG. 7, Controller 704 may include any computing device as described in this disclosure, including without limitation a microcontroller, microprocessor, digital signal processor (DSP) and/or system on a chip (SoC) as described in this disclosure. Computing device may include, be included in, and/or communicate with a mobile device such as a mobile telephone or smartphone. Controller 704 may include a single computing device operating independently, or may include two or more computing device operating in concert, in parallel, sequentially or the like; two or more computing devices may be included together in a single computing device or in two or more computing devices. Controller 704 may interface or communicate with one or more additional devices as described below in further detail via a network interface device. Network interface device may be utilized for connecting controller 704 to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software etc.) may be communicated to and/or from a computer and/or a computing device. Controller 704 may include but is not limited to, for example, a computing device or cluster of computing devices in a first location and a second computing device or cluster of computing devices in a second location. Controller 704 may include one or more computing devices dedicated to data storage, security, distribution of traffic for load balancing, and the like. Controller 704 may distribute one or more computing tasks as described below across a plurality of computing devices of computing device, which may operate in parallel, in series, redundantly, or in any other manner used for distribution of tasks or memory between computing devices. Controller 704 may be implemented using a “shared nothing” architecture in which data is cached at the worker, in an embodiment, this may enable scalability of system 100 and/or computing device.

With continued reference to FIG. 7, controller 704 may be designed and/or configured to perform any method, method step, or sequence of method steps in any embodiment described in this disclosure, in any order and with any degree of repetition. For instance, controller 704 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Controller 704 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

Still referring to FIG. 7, in some cases, controller 704 and/or hinge sensor 744a-b may perform one or more signal processing steps on a signal. For instance, controller 704 and/or hinge sensor 744a-b may analyze, modify, and/or synthesize a signal representative of data in order to improve the signal, for instance by improving transmission, storage efficiency, or signal to noise ratio. Exemplary methods of signal processing may include analog, continuous time, discrete, digital, nonlinear, and statistical. Analog signal processing may be performed on non-digitized or analog signals. Exemplary analog processes may include passive filters, active filters, additive mixers, integrators, delay lines, compandors, multipliers, voltage-controlled filters, voltage-controlled oscillators, and phase-locked loops. Continuous-time signal processing may be used, in some cases, to process signals which varying continuously within a domain, for instance time. Exemplary non-limiting continuous time processes may include time domain processing, frequency domain processing (Fourier transform), and complex frequency domain processing. Discrete time signal processing may be used when a signal is sampled non-continuously or at discrete time intervals (i.e., quantized in time). Analog discrete-time signal processing may process a signal using the following exemplary circuits sample and hold circuits, analog time-division multiplexers, analog delay lines and analog feedback shift registers. Digital signal processing may be used to process digitized discrete-time sampled signals. Commonly, digital signal processing may be performed by a computing device or other specialized digital circuits, such as without limitation an application specific integrated circuit (ASIC), a field-programmable gate array (FPGA), or a specialized digital signal processor (DSP). Digital signal processing may be used to perform any combination of typical arithmetical operations, including fixed-point and floating-point, real-valued and complex-valued, multiplication and addition. Digital signal processing may additionally operate circular buffers and lookup tables. Further non-limiting examples of algorithms that may be performed according to digital signal processing techniques include fast Fourier transform (FFT), finite impulse response (FIR) filter, infinite impulse response (IIR) filter, and adaptive filters such as the Wiener and Kalman filters. Statistical signal processing may be used to process a signal as a random function (i.e., a stochastic process), utilizing statistical properties. For instance, in some embodiments, a signal may be modeled with a probability distribution indicating noise, which then may be used to reduce noise in a processed signal.

With continued reference to FIG. 7, in some embodiments, aircraft 700 may include at least a transmission system 736a-b. As used in this disclosure, a “transmission system” is a system that is configured to facilitate communication with an outboard flight component 724a-b, for instance by transmitting signals thereto from controller or other elements; for example communication may include fluidic communication, mechanical communication, hydraulic communication, wired or wireless electrical communication and the like. In some cases, transmission system 728a-b may be configured to transmit power to an outboard flight component 724a-b. In some cases, at least a transmission system 728a-b may be configured to communicate with outboard flight component 728a-b and permit folding of at least a wing 712a-b. For example, commonly aircraft systems for communication and power transmission involve cables, wires, tubing, hose, linkages, and the like. These transmission systems in order to service an outboard flight component 724a-b must traverse at least a hinge 720a-b to access a foldable (i.e., distal) portion of at least a wing 712a-b. Transmission system 736a-b in some cases permits moving of wings 712a-b without interruption of communication to outboard flight component 724a-b. For example, in some cases, transmission system 736a-b may include at least a service loop, which is configured to prevent the transmission system from interfering with motion of at least a wing 712a-b, when wing is folded and/or unfolded. As sued in this disclosure, a “service loop” is an extra length of wire, cable, conduit, tubing, hose, or the like. In some cases, a service loop may be included in transmission system for neatness, accessibility, freedom of movement or future serviceability. Alternatively or additionally, in some cases, transmission system 736a-b may interrupt communication with an outboard flight component 724a-b as a function of a folded state (e.g., folded or unfolded) of at least a wing 712a-b. For example, in some cases a transmission system 736a-b may include a connection, which may be disconnected when at least a wing 712a-b is folded.

Still referring to FIG. 7, in some embodiments, aircraft 700 may include at least a lock 740a-b. At least a lock 740a-b may be configured to arrest motion of at least a wing 712a-b, for example when the at least a wing is folded and/or unfolded. As used in this disclosure, a “lock” is device that is configured to arrest movement. In some cases, a lock may include a mechanism. Exemplary locking mechanisms include pawls, pins, threaded fasteners, gears, worm gears, springs, linkages, and the like. system of claim 1, further comprising a lock configured to arrest movement of the hinge. In some cases, at least a lock 740a-b may be further configured to resist one or more of wing moments and wing forces. Exemplary wing moments and wing forces include without limitation wing bending moments, wing torsional moments, and wing shear moments. In some cases, wing moments and wing forces may result from one or more of drag, thrust, and lift acting on wing, for example during flight. In some cases, wing moments and wing may result from more episodic loadings, such as those resulting from turbulence during flight.

Still referring to FIG. 7, in some embodiments, aircraft 700 may include at least a hinge sensor 744a-b. In some cases, at least a hinge sensor 744a-b may be in communication with controller 704. Hinge sensor 744a-b may be configured to detect a hinge phenomenon and transmit hinge data to controller 704 as a function of the hinge phenomenon. As used in this disclosure, a “hinge sensor” is a device configured to detect a phenomenon associated directly or indirectly with a hinge. Hinge sensor may communicate hinge data as a function of a detected phenomenon. For example, a hinge sensor may transduce hinge data from detected phenomenon. In some cases, hinge data may be represented by way of a signal, such as without limitation a hinge signal. “Hinge signal,” as used in this disclosure, is a signal that represents hinge data. Hinge sensor 744a-b may include any sensor. Hinge signal may include any signal described in this disclosure, for example digital or analog. Exemplary sensors include positional sensors, motion sensors, temperature sensors, vibration sensors, and the like. In some cases, hinge sensor 744a-b may include a plurality of sensors or a sensor suite. In some cases, hinge sensor 744a-b may include a switch to determine a state of a hinge (e.g., folded or unfolded). In some cases, hinge sensor 744a-b may be configured to determine if a lock mechanism 740a-b is engaged. Hinge sensor 744a-b may include a proximity sensor, such as an ultrasound or Hall effect sensor. In some cases, hinge sensor 744a-b may detect an electrical phenomenon, for instance resistance, capacitance, and the like. In some cases, hinge sensor 744a-b may be configured to detect loading at a hinge 720a-b, a lock 740a-b, or another aircraft component. For instance, in some cases, hinge sensor 744a-b may include a strain gauge, a load cell, or the like. Hinge sensor 744a-b may alternatively include an angular position sensor, such as a rotary encoder, a Hall effect rotary encoder, or the like.

Still referring to FIG. 7, aircraft 700 can be shown to have an unfolded wingspan 748 which is substantially greater than folded wingspan 752. As described above, this may be advantageous as a smaller folded wingspan may be less than maximum permitted wingspan for various airports and thereby increase airport compatibility. In some cases, a blended wing body aircraft 700 may require a larger wingspan 748, however present airport terminals may not allow for wingspans over a certain length. By allowing blending wing body aircraft 700 to fold wings and thereby reduce wingspan, more airports may be utilized by this exciting and more efficient new aircraft type.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

FIG. 8 shows a diagrammatic representation of one embodiment of a computing device in the exemplary form of a computer system 800 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 800 includes a processor 804 and a memory 808 that communicate with each other, and with other components, via a bus 816. Bus 816 may include any of several types of bus structures including, but not limited to, a memory bus, a memory controller, a peripheral bus, a local bus, and any combinations thereof, using any of a variety of bus architectures.

Processor 804 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 804 may be organized according to Von Neumann and/or Harvard architecture as a non-limiting example. Processor 804 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating point unit (FPU), and/or system on a chip (SoC).

Memory 808 may include various components (e.g., machine-readable media) including, but not limited to, a random-access memory component, a read only component, and any combinations thereof. In one example, a basic input/output system 816 (BIOS), including basic routines that help to transfer information between elements within computer system 800, such as during start-up, may be stored in memory 808. Memory 808 may also include (e.g., stored on one or more machine-readable media) instructions (e.g., software) 860 embodying any one or more of the aspects and/or methodologies of the present disclosure. In another example, memory 808 may further include any number of program modules including, but not limited to, an operating system, one or more application programs, other program modules, program data, and any combinations thereof.

Computer system 800 may also include a storage device 864. Examples of a storage device (e.g., storage device 864) include, but are not limited to, a hard disk drive, a magnetic disk drive, an optical disc drive in combination with an optical medium, a solid-state memory device, and any combinations thereof. Storage device 864 may be connected to bus 816 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 864 (or one or more components thereof) may be removably interfaced with computer system 800 (e.g., via an external port connector (not shown)). Particularly, storage device 864 and an associated machine-readable medium 868 may provide nonvolatile and/or volatile storage of machine-readable instructions, data structures, program modules, and/or other data for computer system 800. In one example, software 860 may reside, completely or partially, within machine-readable medium 868. In another example, software 860 may reside, completely or partially, within processor 804.

Computer system 800 may also include an input device 886. In one example, a user of computer system 800 may enter commands and/or other information into computer system 800 via input device 886. Examples of an input device 886 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 886 may be interfaced to bus 816 via any of a variety of interfaces (not shown) including, but not limited to, a serial interface, a parallel interface, a game port, a USB interface, a FIREWIRE interface, a direct interface to bus 816, and any combinations thereof. Input device 886 may include a touch screen interface that may be a part of or separate from display 886, discussed further below. Input device 886 may be utilized as a user selection device for selecting one or more graphical representations in a graphical interface as described above.

A user may also input commands and/or other information to computer system 800 via storage device 864 (e.g., a removable disk drive, a flash drive, etc.) and/or network interface device 840. A network interface device, such as network interface device 840, may be utilized for connecting computer system 800 to one or more of a variety of networks, such as network 844, and one or more remote devices 848 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 844, may employ a wired and/or a wireless mode of communication. In general, any network topology may be used. Information (e.g., data, software 860, etc.) may be communicated to and/or from computer system 800 via network interface device 840.

Computer system 800 may further include a video display adapter 856 for communicating a displayable image to a display device, such as display device 886. Examples of a display device include, but are not limited to, a liquid crystal display (LCD), a cathode ray tube (CRT), a plasma display, a light emitting diode (LED) display, and any combinations thereof. Display adapter 856 and display device 886 may be utilized in combination with processor 804 to provide graphical representations of aspects of the present disclosure. In addition to a display device, computer system 800 may include one or more other peripheral output devices including, but not limited to, an audio speaker, a printer, and any combinations thereof. Such peripheral output devices may be connected to bus 816 via a peripheral interface 856. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods, systems, and software according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

1. A commercial aircraft for short distance air travel, the commercial aircraft comprising:
a blended wing body having a main body, a transition, and wings with no clear demarcation between the wings and the main body along a leading edge of the commercial aircraft, wherein the transition comprises a section of the blended wing body between the main body and the wings, wherein the wings comprise folding wings;
a passenger cabin, the passenger cabin located within the main body and having a wide body passenger capacity;
at least a propulsor, the at least a propulsor attached to a portion of the main body and configured to propel the commercial aircraft through air;
a fuel storage located within the transition of the blended wing body, the fuel storage configured for a fuel capacity associated with short-range flight; and
a landing gear, the landing gear located on an undercarriage of the blended wing body, wherein the commercial aircraft further comprises:
a lock configured to arrest movement of the folding wings; and
a sensor configured to detect a locked and unlocked status of the lock.

2. The commercial aircraft of claim 1, wherein the passenger cabin comprises an ascending layout.

3. The commercial aircraft of claim 1, wherein the passenger cabin comprises a single deck with cargo and passenger located on or above the single deck.

4. The commercial aircraft of claim 1, wherein the wide body passenger capacity contains a maximum passenger capacity of at least 200 passengers.

5. The commercial aircraft of claim 1, wherein wide body passenger capacity contains a maximum passenger capacity of at least 300 passengers.

6. The commercial aircraft of claim 1, wherein the wide body passenger capacity comprises a wide body seat size.

7. The commercial aircraft of claim 1, wherein the passenger cabin includes more than two passenger aisles, the more than two passenger aisles are parallel to each other.

8. The commercial aircraft of claim 1, wherein the short-range flight comprises a maximum flight time of 6.5 hours.

9. The commercial aircraft of claim 1, wherein the transition increases in chord and thickness from the wings towards the main body.

10. The commercial aircraft of claim 1, wherein more than one forward entry doors are located on the transition.

11. The commercial aircraft of claim 1, wherein the commercial aircraft further includes a structural element, the structural element extending vertically from a lower surface of the main body toward an upper surface of the main body.

12. The commercial aircraft of claim 11, wherein the structural element extends from a first distal end of passenger cabin in a direction toward a second distal end of passenger cabin.

13. (canceled)

14. The commercial aircraft of claim 1, further comprising:
a hinge located on a portion of the wings and configured to allow folding of the folding wings;
an actuation system configured to fold the folding wings; and
a controller configured to control the actuation system.

15. (canceled)

16. The commercial aircraft of claim 1, the passenger cabin comprising at least one passenger row, wherein the at least one passenger row contains 8 or more passenger seats.

17. The commercial aircraft of claim 1, wherein the passenger cabin contains a maximum packing efficiency of 0.83

18. The commercial aircraft of claim 1, wherein the passenger cabin comprises more than one cabin bays, the more than one cabin bays separated by a wall.

19. The commercial aircraft of claim 1, wherein the commercial aircraft comprises a maximum fuel capacity of between 200 and 300 pounds of fuel per passenger.

20. The commercial aircraft of claim 1, wherein the commercial aircraft comprises a maximum fuel capacity of 150 pounds of fuel per passenger.

21. The commercial aircraft of claim 1, wherein the commercial aircraft further comprises:
a hinge located on a portion of the wings and configured to allow folding of the folding wings; and
a hinge sensor configured to detect loading at the hinge
